(19) United States
(12) Patent Application Publication
(10) Pub. No.: US 2025/0347792 A1
(43) Pub. Date: Nov. 13, 2025

(54) CORRECTION OF WIRELESS SIGNALS FOR DISTANCE MEASUREMENTS

(71) Applicant: Juniper Networks, Inc., Sunnyvale, CA (US)

(72) Inventors: Scott Morgan Bowers, Mountain View, CA (US); Vladimir Vladimirovich Kozin, Livermore, CA (US); Mohammad Zohoorian, San Francisco, CA (US)

(21) Appl. No.: 18/872,796

(22) PCT Filed: Jun. 30, 2023
(86) PCT No.: PCT/US2023/069525

§ 371 Date: Dec. 6, 2024

Related U.S. Application Data
(60) Provisional application No. 63/367,377, filed on Jun. 30, 2022.
(60) Provisional application No. 63/492,403, filed on Mar. 27, 2023.

(51) Int. Cl. G01S 11/06; G01S 13/76

(52) U.S. Cl. CPC G01S 11/06; G01S 13/76

(57) ABSTRACT

In an example, a method includes obtaining a first plurality of distance measurements for each of a plurality of wireless signals transmitted between a first wireless device and a second wireless device, wherein a distance between the first wireless device and the second wireless device is known; determining coefficients of a polynomial function describing a relationship between estimate errors introduced to the obtained first plurality distance measurements by multipath signals and a statistical spread of the obtained first plurality of distance measurements; obtaining a second plurality of distance measurements for each of a plurality of wireless signals transmitted between a third wireless device and a fourth wireless device, wherein a distance between the third wireless device and the fourth wireless device is unknown; and correcting each of the second plurality of distance measurements based on the determined coefficients of the polynomial function.

This application claims the benefit of U.S. Provisional Patent Application No. 63/492,403, filed 27 Mar. 2023 and U.S. Provisional Patent Application No. 63/367,377, filed 30 Jun. 2022, the entire contents of which is incorporated herein by reference.

### TECHNICAL FIELD

The disclosure relates generally to computer networks and, more specifically, to correction of wireless signals for distance measurements.

### BACKGROUND

Commercial premises, such as offices, hospitals, airports, stadiums, or retail outlets, often include a network of wireless access points (APs) installed throughout the premises to provide wireless network services to one or more wireless client devices. APs enable client devices to wirelessly connect to a wired network using various wireless networking protocols and technologies, such as wireless local area networking protocols conforming to one or more of the IEEE 802.11 standards (i.e., “Wi-Fi”), Bluetooth/Bluetooth Low Energy (BLE), mesh networking protocols such as ZigBee or other wireless networking technologies. Many different types of wireless client devices, such as laptop computers, smartphones, tablets, wearable devices, appliances, Bluetooth beacons and Internet of Things (IoT) devices, incorporate wireless communication technology and can be configured to connect to wireless access points when the device is in range of a compatible wireless access point in order to access a wired network. Location services that may be provided in conjunction with a wireless network include wayfinding, location-based proximity notifications, asset tracking, and location-based analytics that derive insights from client mobility through the premises.

### SUMMARY

In general, the present disclosure describes one or more techniques for using measured information to correct wireless signals for distance determinations of devices in a wireless network. For example, a plurality of devices (e.g., access points (APs)) may be deployed throughout a premises to establish a wireless network at a customer site. However, when the wireless signal between two APs experiences multipath, the distance measurements (e.g., Round Trip Time (RTT) measurements, Received Signal Strength Indicator (RSSI) measurements, etc.) between the two APs can provide an erroneous indication about the distance between the two APs. In accordance with one or more techniques of the disclosure, the wireless signals are corrected, which result in more accurate distance determinations of the APs in the wireless network.

In one example, a polynomial relationship between a spread of obtained RTT measurements and an associated error in the obtained RTT measurements may be used to correct the obtained RTT measurements. For example, RTT measurements (or in some examples, RSSI measurements) are used to determine location of an AP in the wireless network but may be skewed by multipath present in the wireless signal. In some examples, a system determines coefficients of a polynomial function describing a relationship between estimate errors introduced to the obtained first plurality RTT measurements by multipath signals and a statistical spread of the obtained first plurality of RTT measurements. The determined coefficients are used to determine an error associated with each RTT measurement, and the determined error is used to correct the obtained RTT measurements.

In another example, channel state information (CSI) is used to determine an amount of multipath present in a wireless signal. In some examples, the amount of multipath in a wireless signal is determined based on amplitude and/or phase information in the CSI information obtained for the wireless signal over a period of time. In some examples, the amount of multipath in a wireless signal transmitted between two APs is used as an indication of the relative accuracy of a corresponding distance measurement (e.g., RTT, RSSI, etc.) based on the wireless signal that is indicative of a distance between two APs. In other examples, the amount of multipath in a wireless signal transmitted between two APs is indicative of whether an AP is an “outlier” AP, e.g., an AP that is relatively isolated with respect to other APs. An AP can be considered an outlier with respect to its geographic deployment and/or with respect to its ability to communicate with other APs in the wireless network. In other examples, the amount of multipath may be used for purposes of radio resource management (RRM) in order to learn and optimize the radio frequency (RF) environment at the site. In other examples, the determination of the amount of multipath in wireless signals in accordance with the techniques of the disclosure is applicable to other use cases for purposes of monitoring and management of wireless networks, and the disclosure is not limited in this respect.

In some examples, distance measurements based on wireless signals that satisfy a threshold amount of multipath based on the CSI phase information are selected for purposes of determining the locations of the APs in the wireless network. In this way, distance measurements that are affected by multipath (e.g., in which too much measurement error is present due to multipath) are not used/considered for purposes of determining the location of the APs in the wireless network. In some examples, a correction corresponding to the amount of multipath in the wireless signal is applied to distance measurements that are determined to have more than the threshold amount of multipath. These corrected distance measurements are considered for purposes of determining the location of the APs in the wireless network. The techniques described herein may also apply to determining locations of any type of computing devices in a wireless network.

The techniques of the disclosure may provide one or more technical advantages and practical applications. The techniques enable a system to reduce the errors in determining a distance between devices of a wireless network, and thus provide a more accurate determination of location of the devices in a wireless network. For example, by correcting errors from determined coefficients of a polynomial function describing a relationship between estimate errors introduced to the obtained first plurality RTT measurements by multipath signals and a statistical spread of the obtained first plurality of RTT measurements, the location of devices in a wireless network may be more accurately determined with only RTT or RSSI measurements, and may eliminate the need for onsite technicians to determine the positions of the devices in the wireless network. Moreover, by selecting measurements to be used in an AP location determination process based on determining an amount of multipath present in wireless signals communicated between wireless devices associated with a wireless network, only distance measurements (such as RTT and/or RSSI measurements) having less than a threshold amount of multipath are considered for purposes of determining the locations of the deployed APs, thus increasing the accuracy of the determined AP locations. In addition, in examples where a correction corresponding to the amount of multipath is applied to distance measurements associated with the wireless signal, a greater number of RTT/RSSI distance measurements may be available for use when determining locations of deployed APs. In general, the more distance measurements between two APs that are available, the more accurate are the determined distances between the two APs and also the determined locations of the two APs. Also, having more distance measurements available means there may be fewer APs for which there are insufficient distance measurements on which to determine the APs location. The ability to automatically and accurately determine the location of deployed APs may greatly reduce the cost to deploy a wireless network because it is not necessary to dispatch technicians to conduct a survey of the entire site. Determination of APs location using channel state information increases the accuracy of the determined AP locations as compared to the error-prone and time-consuming process of manually measuring the locations of hundreds or even thousands of AP locations. In addition, the techniques may be used to detect when an AP is moved or when a new AP is installed, e.g., as a replacement for a faulty AP, in a slightly different location. Yet another benefit is that the techniques facilitate automated and remote verification of AP deployment locations without necessitating dispatching technicians to conduct an on-site survey. The techniques further provide ability to identify AP(s) that are experiencing a relatively greater amount of multipath and generate a notification including a recommendation to move the AP(s) to a new/different location where they would experience a lesser amount of multipath. In other examples, the techniques provide for identification of outlier APs in a wireless network. In such examples, the system may automatically generate notifications including an identification of one or more outlier APs and/or a recommendation to move the outlier APs to a new or different location including relatively less multipath, or to adjust the environment around the AP so that wireless signals communicated to and/or from the AP experiences less multipath. This can further increase the operational performance of the wireless network as fewer signals associated with high multipath will be present in the wireless network. The techniques support the provision of highly accurate location-based services at a site, which depend upon the locations of each of AP being known to a high degree of accuracy. In addition, the CSI information and/or amount of multipath present in wireless signals transmitted between a plurality of APs in a wireless network determined as described herein may further be used for RF coverage optimization and radio resource management (RRM) of the APs at the site, such as channel and transmit power level selection.

In one example, the disclosure describes a system comprising: one or more processors; and a memory comprising instructions that when executed by the one or more processors cause the one or more processors to: obtain a first plurality of distance measurements for each of a plurality of wireless signals transmitted between a first wireless device and a second wireless device, wherein a distance between the first wireless device and the second wireless device is known; determine coefficients of a polynomial function describing a relationship between estimate errors introduced to the obtained first plurality of distance measurements by multipath signals and a statistical spread of the obtained first plurality of distance measurements; obtain a second plurality of distance measurements for each of a plurality of wireless signals transmitted between a third wireless device and a fourth wireless device, wherein a distance between the third wireless device and the fourth wireless device is unknown; and correct each of the second plurality of distance measurements based on the determined coefficients of the polynomial function.

In another example, the disclosure describes a system comprising: one or more processors; and a memory comprising instructions that when executed by the one or more processors cause the one or more processors to: obtain channel state information (CSI) information for each of a plurality of wireless signals transmitted between a first wireless device and a second wireless device; for each of the plurality of wireless signals, determine an amount of multipath of the wireless signal based on the CSI information; for each of the plurality of wireless signals, compare the amount of multipath of the wireless signal to a threshold; select distance measurements between the first wireless device and the second wireless device corresponding to the wireless signals for which the amount of multipath satisfies the threshold; and determine a distance between the first wireless device and the second wireless device based on the selected distance measurements.

In one example, the disclosure describes a method comprising: obtaining a first plurality of distance measurements for each of a plurality of wireless signals transmitted between a first wireless device and a second wireless device, wherein a distance between the first wireless device and the second wireless device is known; determining coefficients of a polynomial function describing a relationship between estimate errors introduced to the obtained first plurality of distance measurements by multipath signals and a statistical spread of the obtained first plurality of distance measurements; obtaining a second plurality of distance measurements for each of a plurality of wireless signals transmitted between a third wireless device and a fourth wireless device, wherein a distance between the third wireless device and the fourth wireless device is unknown; and correcting each of the second plurality of distance measurements based on the determined coefficients of the polynomial function.

In another example, the disclosure describes a method comprising: obtaining channel state information (CSI) information for each of a plurality of wireless signals transmitted between a first wireless device and a second wireless device; for each of the plurality of wireless signals, determining an amount of multipath of the wireless signal based on the CSI information; for each of the plurality of wireless signals, comparing the amount of multipath of the wireless signal to a threshold; selecting distance measurements between the first wireless device and the second wireless device corresponding to the wireless signals for which the amount of multipath satisfies the threshold; and determining a distance between the first wireless device and the second wireless device based on the selected distance measurements

In one example, the disclosure describes non-transitory computer-readable media comprising instructions that when executed by the one or more processors cause the one or more processors to: obtain a first plurality of distance measurements for each of a plurality of wireless signals transmitted between a first wireless device and a second wireless device, wherein a distance between the first wireless device and the second wireless device is known; determine coefficients of a polynomial function describing a relationship between estimate errors introduced to the obtained first plurality of distance measurements by multipath signals and a statistical spread of the obtained first plurality of distance measurements; obtain a second plurality of distance measurements for each of a plurality of wireless signals transmitted between a third wireless device and a fourth wireless device, wherein a distance between the third wireless device and the fourth wireless device is unknown; and correct each of the second plurality of distance measurements based on the determined coefficients of the polynomial function.

In another example, the disclosure describes non-transitory computer-readable media comprising instructions that when executed by the one or more processors cause the one or more processors to: obtain channel state information (CSI) information for each of a plurality of wireless signals transmitted between a first wireless device and a second wireless device; for each of the plurality of wireless signals, determine an amount of multipath of the wireless signal based on the CSI information; for each of the plurality of wireless signals, compare the amount of multipath of the wireless signal to a threshold; select distance measurements between the first wireless device and the second wireless device corresponding to the wireless signals for which the amount of multipath satisfies the threshold; and determine a distance between the first wireless device and the second wireless device based on the selected distance measurements.

In one example, the disclosure describes a system comprising: a plurality of access point devices (APs) deployed to provide a wireless network at a site; and a computing device comprising: one or more processors; and a memory comprising instructions that when executed by the one or more processors cause the one or more processors to: obtain a first plurality of distance measurements for each of a plurality of wireless signals transmitted between a first wireless device and a second wireless device, wherein a distance between the first wireless device and the second wireless device is known; determine coefficients of a polynomial function describing a relationship between estimate errors introduced to the obtained first plurality of distance measurements by multipath signals and a statistical spread of the obtained first plurality of distance measurements; obtain a second plurality of distance measurements for each of a plurality of wireless signals transmitted between a third wireless device and a fourth wireless device, wherein a distance between the third wireless device and the fourth wireless device is unknown; and correct each of the second plurality of distance measurements based on the determined coefficients of the polynomial function.

In another example, the disclosure describes a system comprising: a plurality of access point devices (APs) deployed to provide a wireless network at a site; and a computing device comprising: one or more processors; and a memory comprising instructions that when executed by the one or more processors cause the one or more processors to: obtain channel state information (CSI) information for each of a plurality of wireless signals transmitted between a first AP and a second AP; for each of the plurality of wireless signals, determine an amount of multipath of the wireless signal based on the CSI information; for each of the plurality of wireless signals, compare the amount of multipath of the wireless signal to a threshold; select distance measurements between the first AP and the second AP corresponding to the wireless signals for which the amount of multipath satisfies the threshold; and determine a distance between the first AP and the second AP based on the selected distance measurements.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1A is a diagram of an example network system in which locations of deployed access points (APs) are determined based on corrected wireless signals, in accordance with one or more techniques of the disclosure.

FIG. 1B is a block diagram illustrating further example details of the network system of FIG. 1A.

FIG. 2 is a block diagram of an example access point device, in accordance with one or more techniques of this disclosure.

FIG. 3 is a block diagram of an example network management system configured to determine locations of deployed APs using RTT information and/or channel state information, in accordance with one or more techniques of the disclosure.

FIG. 4 is a block diagram of an example user equipment device, in accordance with one or more techniques of this disclosure.

FIG. 5 is a block diagram of an example network node, such as a router or switch, in accordance with one or more techniques of this disclosure.

FIG. 6 is a diagram of an example multipath wireless environment including LOS and NLOS signal paths.

FIGS. 7A and 7B illustrate examples of RTT estimation in specific environments, in accordance with one or more techniques of the disclosure.

FIG. 8 is a graph illustrating RTT errors as a function of the spread, in accordance with one or more techniques of the disclosure.

FIG. 9 is a flowchart of an example process by which a computing device corrects the measured RTT/RSSI values using the spread in distance measurements, in accordance with one or more techniques of the disclosure.

FIG. 10 is a flowchart of an example process by which a computing device determines coefficients of a polynomial function used for correction of the measured RTT values, in accordance with one or more techniques of the disclosure.

FIG. 11 is a flowchart of an example process by which a computing device reduces errors introduced by multipath in the RTT measurements, in accordance with one or more techniques of the disclosure.

FIG. 12 is a flowchart of an example process by which a computing device uses the estimated RTT errors for determining which RTT measurements provide reliable means for determining the distance between a transmitting antenna and a receiving antenna, in accordance with one or more techniques of the disclosure.

FIG. 13 is a flowchart of an example process by which a computing device uses the estimated RTT errors for determining which APs can be used as anchor APs.

FIG. 14A is a diagram of an example multipath wireless environment including LOS and NLOS signal paths.

FIG. 14B is a diagram of an example channel state information (CSI) vector sample.

FIGS. 15A-15D are histograms of variance in the CSI phase bins for example LOS and NLOS environments, in accordance with one or more techniques of the disclosure.

FIG. 16A is a graph of variance in the CSI phase bins for LOS and NLOS environments, in accordance with one or more techniques of the disclosure.

In FIG. 16B is a table of amounts of multipath in an NLOS signal and corresponding factors, in accordance with one or more techniques of the disclosure.

FIG. 17 is a flowchart of an example process by which a network management system determines locations of deployed APs using channel state information, in accordance with one or more techniques of the disclosure.

FIG. 18 is a flowchart of an example process by which a computing device identifies one or more outlier APs in a wireless network based on CSI information, in accordance with one or more techniques of the disclosure.

### DETAILED DESCRIPTION

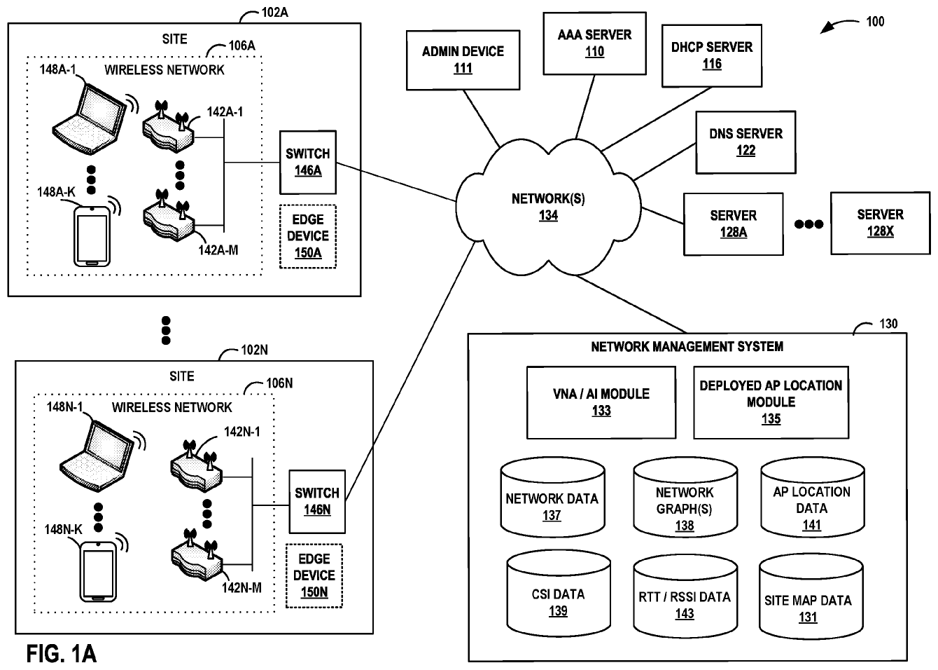

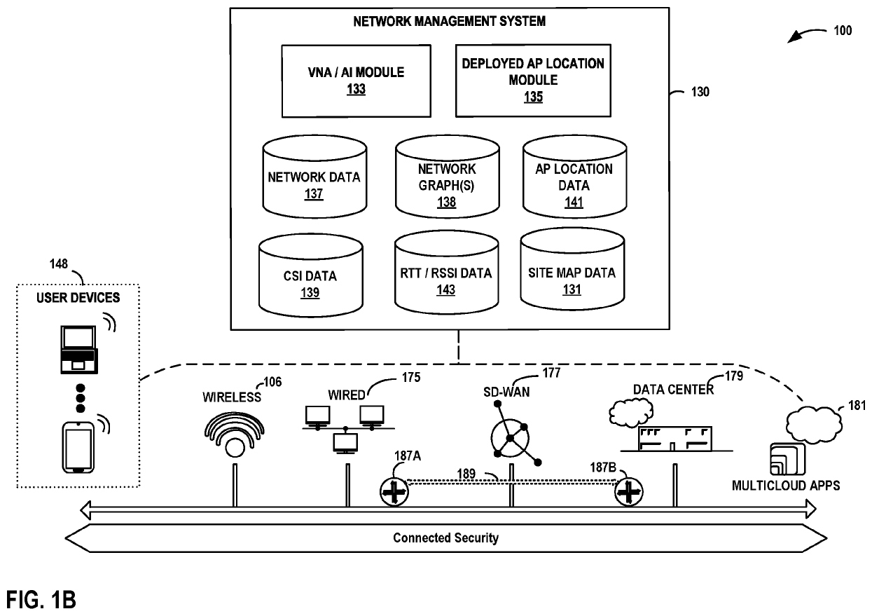

FIG. 1A is a diagram of an example network system in which locations of deployed access points (APs) are determined based on corrected wireless signals, in accordance with one or more techniques of the disclosure. In one example, such locations are determined using Round Trip Time (RTT) measurements corrected with a polynomial relationship between a spread of obtained RTT measurements and an associated error in the obtained RTT measurements. More specifically, a polynomial relationship between a spread of obtained RTT measurements and an associated error in the obtained RTT measurements may be used to correct the obtained RTT measurements between wireless devices, such as deployed APs 142. In another example, channel state information (CSI) is used to determine an amount of multipath in wireless signals communicated between wireless devices, such as deployed AP 142. Although some examples herein are described with respect to APs, the techniques of the disclosure may be used to determine an amount of multipath in wireless signals communicated between any type of wireless devices, including but not limited to APs, routers, adapters, wireless client devices such as smart phones, tablet computers, user equipment (UE) devices, and other mobile devices, IoT, and other connected devices, wireless sensors, tags used for wireless tracking of objects or equipment, etc.

Example network system 100 includes a network management system (NMS) 130 and a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices, such as access points (APs) 142, switches 146, or routers (not shown). For example, site 102A includes a plurality of APs 142A-1 through 142A-M. Similarly, site 102N includes a plurality of APs 142N-1 through 142N-M. Each AP 142 may be any type of wireless access point, including, but not limited to, a commercial or enterprise AP, a router, or any other device that is connected to the wired network and is capable of providing wireless network access to client devices within the site.

Each site 102A-102N also includes a plurality of client devices, otherwise known as user equipment devices (UEs), referred to generally as UEs or client devices 148, representing various wireless-enabled devices within each site. For example, a plurality of UEs 148A-1 through 148A-N are currently located at site 102A. Similarly, a plurality of UEs 148N-1 through 148N-K are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-M at site 102A are connected. Similarly, site 102N includes a switch 146N to which each of APs 142N-1 through 142N-M at site 102N are connected. Although illustrated in FIG. 1A as if each site 102 includes a single switch 146 and all APs 142 of the given site 102 are connected to the single switch 146, in other examples, each site 102 may include more or fewer switches and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and a network management system (NMS) 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device, respectively, associated with one or more of sites 102. Admin device 111 may be implemented as any suitable device for presenting output and/or accepting user input For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e g., APs 142, switches 146, or routers, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, and any other servers or devices attached to or forming part of network system 100, may include a system log or an error log module wherein each one of these network devices records the status of the network device including normal operational status and error conditions. Throughout this disclosure, one or more of the network devices of network system 100. e.g., servers 110, 116, 122 and/or 128, APs 142, UEs 148, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137, e.g., one or more service level expectation (SLE) metrics, received from wireless networks 106A-106N at each site 102A-102N, respectively, and manages network resources, such as APs 142 at each site. to deliver a high-quality wireless experience to end users, IoT devices, and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Pat. No. 10,862,742, issued Dec. 8, 2020, and entitled “Method for Conveying AP Error Codes Over BLE Advertisements,” all of which are incorporated herein by reference in their entirety.

In operation, NMS 130 observes, collects and/or receives network data 137, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

In accordance with the techniques described in this disclosure, NMS 130 includes an AP location module 135 that, when executed by one or more processors of NMS 130, determines locations of deployed APs in a wireless network based on corrected wireless signals. In one example, locations of deployed APs are determined using measurements corrected using a polynomial relationship between a spread of obtained measurements and an associated error in the obtained measurements. In another example, locations of deployed APs are determined using channel state information.

Deployed AP location module 135, when executed by one or more processors of NMS 130 or by any other computing device, determines the location of one or more APs 142 in a wireless network with respect to the site. For example, deployed AP location module 135 may determine coordinate locations of one or more APs associated with a wireless network 106 with respect to a global coordinate system for the associated site 102. The coordinate locations of the APs 142 are determined, for example, based on distance measurements (e.g, RSSI and/or RTT measurements stored in RTT/RSSI data 143) between the APs. In accordance with one or more techniques of the disclosure, corrected RTT/RSSI data 143 and/or CSI data are used to determine the distances between APs and/or the coordinate locations of the APs.

RTT/RSSI data 143 includes a plurality of distance measurements indicative of distances between two APs. RTT/RSSI data is measured by receiving devices. e.g., APs (or UEs 148). The distance measurements may include RTT measurements and/or RSSI measurements of wireless signals communicated between two APs. Example Wi-Fi RTT techniques are described in the IEEE 802.11mc (i.e., IEEE 802.11-2016) standard, which defines a fine-time measurement (FTM) protocol that can be used to measure the Wi-Fi signal RTT between two wireless devices.

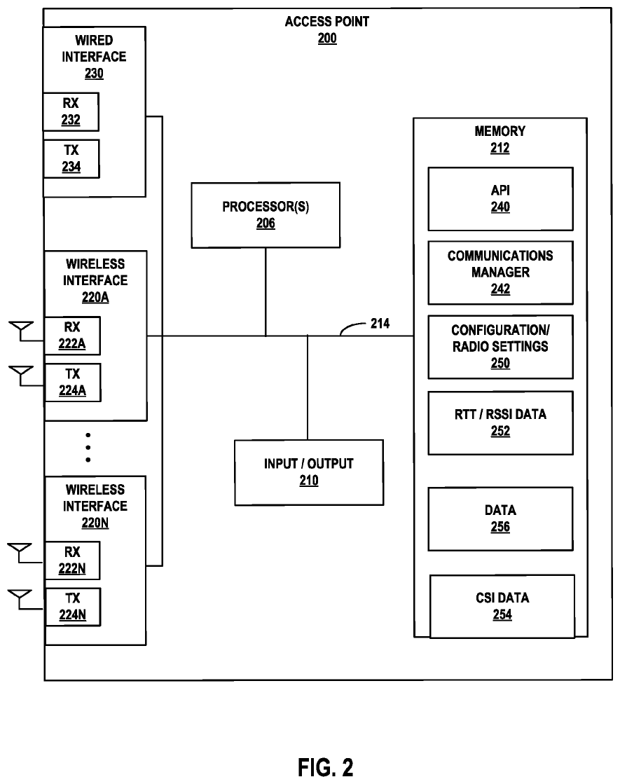

CSI data 139 includes a collection of channel frequency responses, estimated by a plurality of receiving APs (such as, e.g., AP 200 of FIG. 2) from signals transmitted by a plurality of transmitting APs. CSI is a complex vector (I/Q data) which contains amplitude and phase information about the propagation of a wireless signal via a communication channel at specific subcarrier frequencies. The CSI may thus be represented as a vector of amplitude and phase information at each of the subcarrier frequencies.

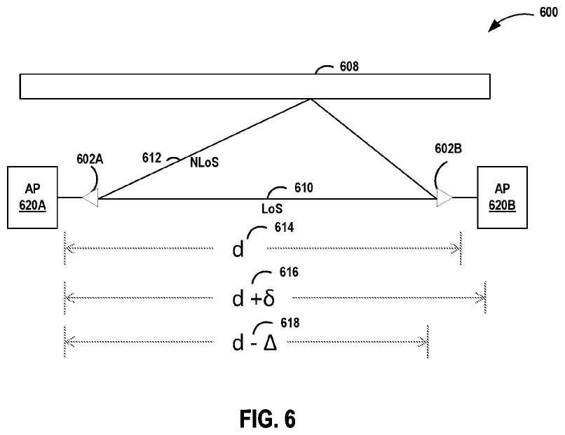

As further described below (e.g., in FIGS. 6-13), NMS 130 may determine coefficients of a polynomial function describing a relationship between estimate errors introduced to the obtained first plurality RTT/RSSI measurements by multipath signals and a statistical spread of the obtained first plurality of RTT/RSSI measurements. The determined coefficients are used to determine an error associated with each RTT measurement and is used to correct the obtained RTT measurements. The corrected RTT measurements are then used to determine the locations of one or more APs associated with a wireless network 106. Although the examples described herein are described with respect to RTT measurements, the techniques may alternatively, or additionally, apply to RSSI measurements.

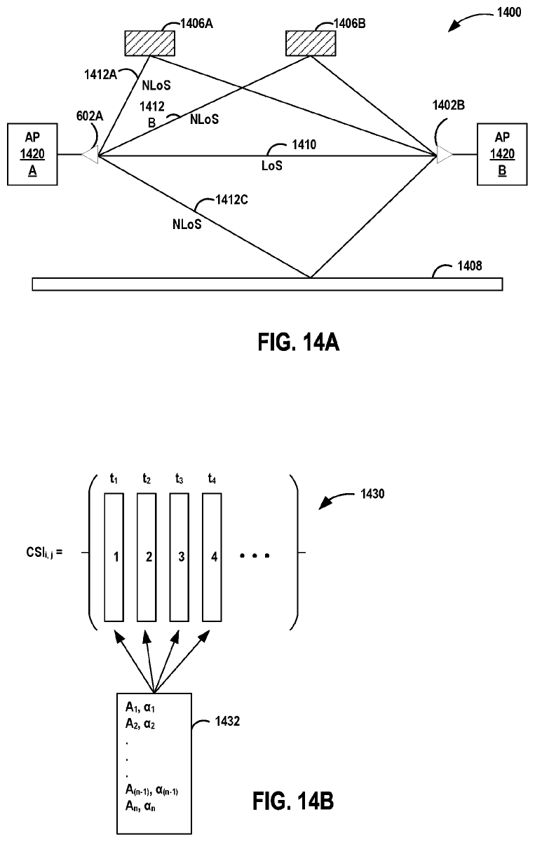

Alternatively, or additionally, NMS 130 may use CSI to determine an amount of multipath present in a wireless signal and select distance measurements based on wireless signals that satisfy a threshold amount of multipath based on the CSI phase information are selected for purposes of determining the locations of the APs in the wireless network, as further described below (e.g., in FIGS. 14-18).

Although the AP location techniques are described herein as being executed by a cloud-based NMS 130, the AP location techniques may be implemented by any computing device, regardless of the specific deployment location, configured to monitor or control one or more aspects of wireless network performance at the sites 102. For example, a local (e.g., server) or edge computing device 150 deployed at each of the sites (or other edge computing device deployed with respect to a group of sites), switch 146, or any other computing device, may include and execute AP location module 135 to determine locations of APs deployed at the associated site or sites. The disclosure is therefore not limited with respect to the location (e.g., cloud-based computing, edge computing, local computing, or any combination thereof) of the computing device or the computing techniques configured to perform the AP location techniques described herein.

FIG. 1B is a block diagram illustrating further example details of the network system of FIG. 1A. In this example, FIG. 1B illustrates NMS 130 configured to operate according to an artificial intelligence and/or machine-learning-based computing platform providing comprehensive automation, insight, and assurance (Wi-Fi Assurance, Wired Assurance and WAN assurance) spanning from “client,” e.g., user devices 148 connected to wireless network 106 and wired LAN 175 at the network edge (far left of FIG. 1B), to “cloud,” e.g., cloud-based application services 181 that may be hosted by computing resources within data centers 179 (far right of FIG. 1B).

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, network management system 130 may be configured to proactively monitor and adaptively configure network 100 so as to provide self-driving capabilities. Moreover, VNA 133 includes a natural language processing engine to provide AI-driven support and troubleshooting, anomaly detection, AI-driven location services, and AI-driven radio frequency (RF) optimization with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services 181. In general, SD-WAN 177 provides seamless, secure, traffic-engineered connectivity between “spoke” routers 187A of wired networks 175 hosting wireless networks 106, such as branch or campus networks, to “hub” routers 187B further up the cloud stack toward cloud-based application services 181. SD-WAN 177 often operates and manages an overlay network on an underlying physical Wide-Area Network (WAN), which provides connectivity to geographically separate customer networks. In other words, SD-WAN 177 extends Software-Defined Networking (SDN) capabilities to a WAN and allows network(s) to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by client devices 148 to steer traffic along selected paths, e.g., path 189, toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR), provided by Juniper Networks, Inc.

Additional information with respect to session-based routing and SVR is described in U.S. Pat. No. 9,729,439, entitled “COMPUTER NETWORK PACKET FLOW CONTROLLER,” and issued on Aug. 8, 2017; U.S. Pat. No. 9,729,682, entitled “NETWORK DEVICE AND METHOD FOR PROCESSING A SESSION USING A PACKET SIGNATURE,” and issued on Aug. 8, 2017; U.S. Pat. No. 9,762,485, entitled “NETWORK PACKET FLOW CONTROLLER WITH EXTENDED SESSION MANAGEMENT,” and issued on Sep. 12, 2017; U.S. Pat. No. 9,871,748, entitled “ROUTER WITH OPTIMIZED STATISTICAL FUNCTIONALITY,” and issued on Jan. 16, 2018; U.S. Pat. No. 9,985,883, entitled “NAME-BASED ROUTING SYSTEM AND METHOD,” and issued on May 29, 2018; U.S. Pat. No. 10,200,264, entitled “LINK STATUS MONITORING BASED ON PACKET LOSS DETECTION,” and issued on Feb. 5, 2019; U.S. Pat. No. 10,277,506, entitled “STATEFUL LOAD BALANCING IN A STATELESS NETWORK,” and issued on Apr. 30, 2019; U.S. Pat. No. 10,432,522, entitled “NETWORK PACKET FLOW CONTROLLER WITH EXTENDED SESSION MANAGEMENT,” and issued on Oct. 1, 2019; and U.S. Pat. No. 11,075,824, entitled “IN-LINE PERFORMANCE MONITORING,” and issued on Jul. 27, 2021, the entire content of each of which is incorporated herein by reference in its entirety.

In some examples, AI-driven NMS 130 may enable intent-based configuration and management of network system 100, including enabling construction, presentation, and execution of intent-driven workflows for configuring and managing devices associated with wireless networks 106, wired LAN networks 175, and/or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations required to achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by only requiring a user/system to specify declarative requirements that specify a desired result applicable across various different types of devices, management and configuration of the network devices becomes more efficient. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” which is hereby incorporated by reference herein in its entirety.

In accordance with one or more techniques of the disclosure, NMS 130 executes deployed AP location module 135 to determine locations of deployed APs in a wireless network based on distance measurements obtained from the plurality of APs. In one example, such location determinations are based on distance measurements (e.g., RTT, RSSI) that are corrected using a polynomial relationship between a spread of obtained distance measurements and an associated error in the obtained distance measurements Alternatively, or additionally, NMS 130 executes deployed AP location module 135 to select distance measurements obtained from the plurality of APs that satisfy a threshold amount of multipath based on CSI.

FIG. 2 is a block diagram of an example access point (AP) device 200 configured in accordance with one or more techniques of this disclosure. Example access point 200 shown in FIG. 2 may be used to implement any of APs 142 as shown and described herein with respect to FIG. 1A. Access point 200 may comprise, for example, a Wi-Fi, Bluetooth and/or Bluetooth Low Energy (BLE) base station or any other type of wireless access point.

In the example of FIG. 2, access point device 200 includes a wired interface 230, wireless interfaces 220A-220B, one or more processor(s) 206, memory 212, and a user interface 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point device 200 to network(s) 134 of FIG. 1A. First and second wireless interfaces 220A and 220B represent wireless network interfaces and include receivers 222A and 222B, respectively, each including a receive antenna via which access point 200 may receive wireless signals from wireless communications devices, such as UEs 148 of FIG. 1A. First and second wireless interfaces 220A and 220B further include transmitters 224A and 224B, respectively, each including transmit antennas via which access point 200 may transmit wireless signals to wireless communications devices, such as UEs 148 of FIG. 1A. In some examples, first wireless interface 220A may include a Wi-Fi 802.11 interface (e.g., 2.4 GHz and/or 5 GHz) and second wireless interface 220B may include a Bluetooth interface and/or a Bluetooth Low Energy (BLE) interface. However, these are given for example purposes only, and the disclosure is not limited in this respect.

Processor(s) 206 are programmable hardware-based processors configured to execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform the techniques described herein.

Memory 212 includes one or more devices configured to store programming modules and/or data associated with operation of access point device 200. For example, memory 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 206 to perform one or more of the techniques described herein.

In this example, memory 212 stores executable software including an application programming interface (API) 240, a communications manager 242, configuration settings 250, RTT/RSSI data 252, CSI data 254, and data storage 256. Data storage 256 may store network data, e.g., network parameters and/or network events, specific to AP device 200 and/or client devices currently or previously associated with AP device 200. The network data may include, for example, any network parameter and/or network data indicative of one or more aspects of performance of the wireless network or of the AP device 200 itself. In some examples, the network data may include a plurality of states measured periodically as time series data. The network data may be measured by the UE devices 148 and transmitted to AP device 200, may be measured by AP device 200 itself or by any other device associated with the wireless network and transmitted to AP device 200.

Network data 256 may include, for example, AP events and/or UE events. In some examples, the network events are classified as positive network events, neutral network events, and/or negative network events. The network events may include, for example, memory status, reboot events, crash events, Ethernet port status, upgrade failure events, firmware upgrade events, configuration changes, authentication events, DNS events, DHCP events, one or more types of roaming events, one or more types of proximity events, etc., as well as a time and date stamp for each event. Data 256 may further store any data used and/or generated by access point device 200, including data collected from UEs 148.

RTT/RSSI data 252 includes data indicative of the distances between AP 200 and one or more other APs in the wireless network. The data may include, for example, RSSI measurements determined by AP 200 of wireless signals transmitted by one or more other APs and received by AP 200, RTT measurements determined by AP 200 of wireless signals traveling from AP 200 to one or more other APs and echoed back by the one or more other APs, etc. In some examples, the wireless signals on which the RSSI and/or RTT measurements are based on transmitted from or between one or more neighbor APs in the wireless network.

In accordance with one or more techniques of the disclosure, NMS 130 or any other computing device, may utilize a polynomial relationship between a spread of obtained RTT measurements (e.g., from AP 200 and other APs in the wireless network managed by NMS 130) and an associated error in the obtained RTT measurement. The computing device may estimate coefficients of the polynomial and may use the estimated coefficients to determine the associated error. The computing device may use the associated error to correct RTT/RSSI data 252. In accordance with one or more techniques of the disclosure, a computing device, such as NMS 130 or any other computing device, selects distance measurements to be used for purposes of determining locations of deployed APs in a wireless network based on the corrected RTT/RSSI data 252 for the corresponding wireless signals transmitted between the APs.

CSI data 254 includes a collection of channel frequency responses, estimated by a receiving AP (e.g., AP 200) from a signal transmitted by a transmitting AP. CSI is a complex vector (I/Q data) which contains amplitude and phase information about the propagation of a signal via a communication channel at specific subcarrier frequencies. The CSI may thus be represented as a vector of amplitude and phase information at each of the subcarrier frequencies. In accordance with one or more techniques of the disclosure, a computing device, such as NMS 130 or any other computing device, selects distance measurements to be used for purposes of determining locations of deployed APs in a wireless network based on CSI data for the corresponding wireless signals transmitted between the APs.

Communications manager 242 includes program code that, when executed by processor(s) 206, allow access point 200 to communicate with UEs 148 and/or network(s) 134 via any of interface(s) 230 and/or 220A-220B. Configuration settings 250 include any device settings for access point 200 such as radio settings for each of wireless interface(s) 220A-220B. These settings may be configured manually or may be remotely monitored and/or automatically managed or configured by NMS 130 to optimize wireless network performance on a periodic (e.g., hourly or daily) basis.

Input/output (I/O) 210 represents physical hardware components that enable interaction with a user, such as buttons, a touchscreen, a display and the like. Although not shown, memory 212 typically stores executable software for controlling a user interface with respect to input received via I/O 210.

In some examples, rather than the NMS 130 determining the locations of deployed APs using channel state information or determining coefficients of polynomial relationship between a spread of obtained RTT measurements and an associated error in the obtained RTT measurement, one or more of the APs 142/200 themselves, edge computing device 150, and/or any other computing device may be configured to determine the locations of one or more of the deployed APs 142/200 using channel state information and/or automatically execute other functionality based on the determined locations.

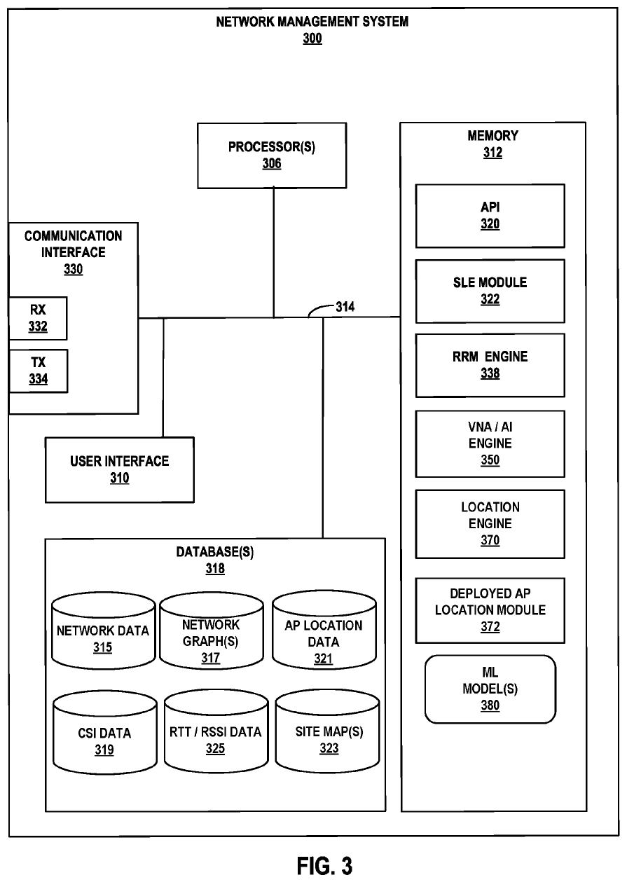

FIG. 3 is a block diagram of an example network management system (NMS) 300 configured to determine locations of deployed APs using RTT information and/or channel state information, in accordance with one or more techniques of the disclosure. NMS 300 may be used to implement, for example, NMS 130 in FIGS. 1A-1B. In such examples, NMS 300 is responsible for monitoring and management of one or more wireless networks 106A-106N at sites 102A-102N, respectively including determining the locations of APs 142/200 using RTT information. In some examples, NMS 300 receives network data collected by AP devices 142/200 and analyzes this data for cloud-based management of wireless networks 106A-106N. In some examples, NMS 300 may be part of another server shown in FIG. 1A or a part of any other server.

NMS 300 includes a communications interface 330, one or more processor(s) 306, a user interface 310, a memory 312, and a database 318. The various elements are coupled together via a bus 314 over which the various elements may exchange data and information.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of AP devices 142, servers 110, 116, 122, 128 and/or any other devices or systems forming part of network 100 such as shown in FIGS. 1A-1B. The data and information received by NMS 300 may include, for example, network data and/or event log data received from APs 142 used by NMS 300 to remotely monitor and/or control the performance of wireless networks 106A-106N and to determine the locations of APs 142. NMS may further transmit data via communications interface 330 to any of network devices such as APs 142 at any of network sites 102A-102N to remotely manage wireless networks 106A-106N.

Memory 312 includes one or more devices configured to store programming modules and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, SLE module 322, a radio resource management (RRM) engine 338, a virtual network assistant (VNA)/AI engine 350, a location engine 370, an AP location module 372, and one or more machine learning models 380. NMS 300 may also include any other programmed modules, software engines and/or interfaces configured for remote monitoring and management of wireless networks 106A-106N, including remote monitoring and management of any of AP devices 142/200.

RRM engine 360 monitors one or more metrics for each site 106A-106N in order to learn and optimize the power and/or radiofrequency (RF) environment at each site. For example, RRM engine 360 may monitor the coverage and capacity SLE metrics (e.g., managed by SLE module 322) for a wireless network 106 at a site 102 in order to identify potential issues with coverage and/or capacity in the wireless network 106 and to adjust the radio settings of the access points at each site to address the identified issues. RRM engine 360 may determine channel and transmit power distribution across all AP devices 142 in each network 106A 106N. RRM engine 360 may monitor events, power, channel, bandwidth, and number of clients connected to each AP device. RRM engine 360 may measure the strength of a radio signal of client devices, such as an RSSI value. RRM engine 360 may further automatically change or update configurations of one or more AP devices 142 at a site 106 with an aim to improve the coverage and/or capacity SLE metrics and thus to provide an improved wireless experience for the user. In some examples, RRM engine 360 may use RTT information and/or an amount of multipath in one or more wireless signals transmitted between wireless devices (such as APs) in a wireless network determined based on corrected RTT information as described herein in order to learn and optimize the RF environment provided by the wireless network (e.g., adjust transmit power of one or more APs, adjust operating frequency or channel for one or more APs, etc.). For example, RRM engine 360 may use RTT information and/or an amount of multipath in one or more wireless signals transmitted between wireless devices (such as APs) in a wireless network determined based on corrected RTT information as described herein in combination with RSSI information as described in U.S. patent application Ser. No. 17/804,780, filed May 31, 2022, and entitled, “Automatic Upgrade Planning,” which is incorporated by reference herein in its entirety.

VNA/AI engine 350 analyzes network data received from AP devices 142 as well as its own data to monitor performance of wireless networks 106A-106N. For example, VNA engine 350 may identify when anomalous or abnormal states are encountered in one of wireless networks 106A-106N. VNA/AI engine 350 may use a root cause analysis module (not shown) to identify the root cause of any anomalous or abnormal states. In some examples, the root cause analysis module utilizes artificial intelligence-based techniques to help identify the root cause of any poor SLE metric(s) at one or more of wireless networks 106A-106N. In addition, VNA/AI engine 350 may automatically invoke one or more remedial actions intended to address the identified root cause(s) of one or more poor SLE metrics. Examples of remedial actions that may be automatically invoked by VNA/AI engine 350 may include, but are not limited to, invoking RRM 360 to reboot one or more AP devices and/or adjust/modify the transmit power of a specific radio in a specific AP device, adjust the operating frequency or channel for a specific AP, adding service set identifier (SSID) configuration to a specific AP device, changing channels on an AP device or a set of AP devices, etc. The remedial actions may further include restarting a switch and/or a router, invoke downloading of new software to an AP device, switch, or router, etc. These remedial actions are given for example purposes only, and the disclosure is not limited in this respect. If automatic remedial actions are not available or do not adequately resolve the root cause, VNA/AI engine 350 may proactively and automatically provide a notification including recommended remedial actions to be taken by IT personnel to address the anomalous or abnormal wireless network operation.

SLE module 322 enables set up and tracking of thresholds for one or more SLE metrics for each of wireless networks 106A-106N. SLE module 322 further analyzes network data (e.g., stored as network data 316) collected by AP devices and/or UEs associated with wireless networks 106A-106N, such as any of AP devices 142 from UEs 148 in each wireless network 106A 106N. For example, AP devices 142A-1 through 142A-N collect network data from UEs 148A-1 through 148A-N currently associated with wireless network 106A (e.g., named assets, connected/unconnected Wi-Fi clients). This data, in addition to any network data collected by one or more APs 142A-1 through 142A-N in wireless network 106A, is transmitted to NMS 300 and stored as, for example, network data 315.

NMS 300 executes SLE module 322 to determine one or more SLE metrics for each UE 148 associated with a wireless network 106. One or more of the SLE metrics may further be aggregated to each AP device at a site to gain insight into contribution of each AP device to wireless network performance at the site. The SLE metrics track whether the service level for each particular SLE metric meets the configured threshold value(s). In some examples, each SLE metric may further include one or more classifiers. If a metric does not meet the configured SLE threshold value for the site, the failure may be attributed to one of the classifiers to further understand how and/or why the failure occurred.

In accordance with the techniques described in this disclosure, NMS 300 includes an AP location module 372. AP location module 372, when executed by one or more processor(s) of NMS 300, determines locations of deployed APs in a wireless network based on distance measurements obtained from the plurality of APs that are corrected using channel state information and/or determined coefficients of a polynomial relationship between a spread of obtained RTT/RSSI measurements and an associated error in the obtained RTT/RSSI measurements.

For example, a computing device, such as NMS 130/300 or other computing device executing deployed AP location module 372, automatically determines locations of one or more APs in the wireless network based on distance measurements between the APs. The distance measurements may be determined using RTT measurements and/or RSSI measurements of wireless signals communicated between two APs. Example Wi-Fi RTT techniques are described in the IEEE 802.11mc (i.e., IEEE 802.11-2016) standard, which defines a FTM protocol that can be used to measure the Wi-Fi signal RTT.

Example techniques for automatically determining locations (e.g., coordinates) of deployed APs based on distance measurements between APs are described in U.S. Provisional Patent Application No. 63/243,616, filed Sep. 13, 2021, and entitled “Determining Locations of Deployed Access Points;” U.S. patent application Ser. No. 17/811,784, filed on Jul. 11, 2022, entitled “Determining Locations of Deployed Access Points, and which claims the benefit of U.S. Provisional Patent Application No. 63/243,616, filed Sep. 13, 2021;” and U.S. Provisional Patent Application No. 63/363,353, filed Apr. 21, 2022, and entitled “Systems and Methods of Determining Floor Locations of Deployed Access Points;” each of which is incorporated by reference herein in its entirety.

NMS 300 further includes a location engine 370. In some examples, a computing device, such as NMS 130/300 or other computing device executing location engine 370, automatically determines locations of one or more wireless client devices associated with a wireless network based on the determined locations of one or more APs. Example techniques for automatically determining locations of wireless client devices are described in U.S. patent application Ser. No. 16/147,327, filed Sep. 28, 2018, and entitled “Methods and Apparatus for Using Received Signal Strength Information in a Wireless System;” U.S. patent application Ser. No. 16/676,812, filed Nov. 7, 2019, and entitled “Wireless Signals for Location Determination;” U.S. patent application Ser. No. 16/915,381, filed Jun. 29, 2020, and entitled “Multi-Wireless Device Location Determination;” U.S. patent application Ser. No. 16/915,447, filed Jun. 29, 2020, and entitled “Determining Location Determination Based on Phase Differences;” U.S. patent application Ser. No. 17/453,752, filed Nov. 5, 2021, and entitled “Determining Location Based on Dynamic Path Loss Exponent (PLE) and Intercept (INT) Estimation;” and U.S. patent application Ser. No. 17/644,033, filed Dec. 13, 2021, and entitled “Wi-Fi Location Enhancement,” each of which is incorporated by reference herein in its entirety.

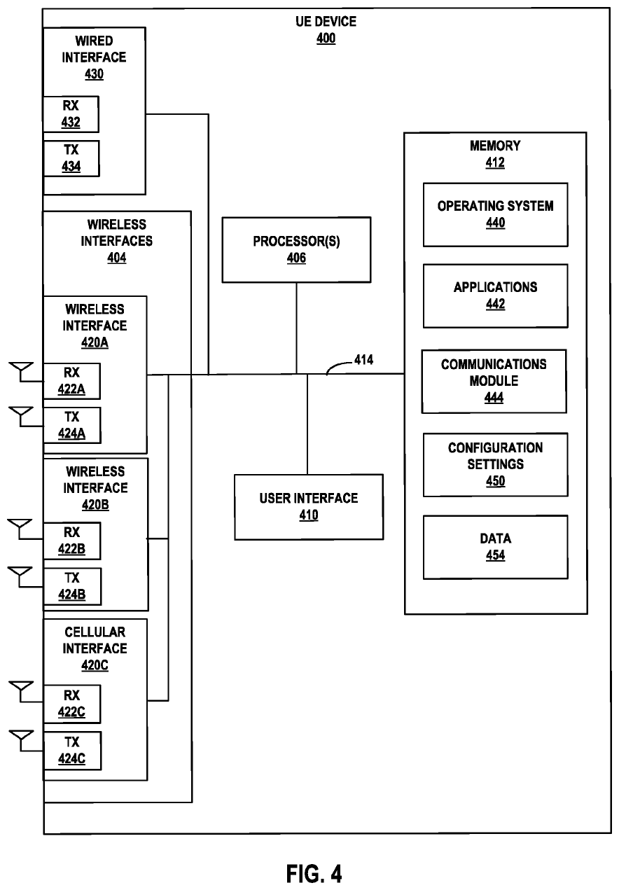

FIG. 4 shows an example user equipment (UE) device 400. Example UE device 400 shown in FIG. 4 may be used to implement any of UEs 148 as shown and described herein with respect to FIG. 1. UE device 400 may include any type of wireless client device, and the disclosure is not limited in this respect. For example, UE device 400 may include a mobile device such as a smart phone, tablet or laptop computer, a personal digital assistant (PDA), a wireless terminal, a Bluetooth beacon, a smart watch, a smart ring or any other type of mobile or wearable device. UE 400 may also include any type of IoT client device such as a printer, a security sensor or device, an environmental sensor, or any other connected device configured to communicate over one or more wireless networks.

In accordance with one or more techniques of the disclosure, NMS 130 receives relevant network data from UEs 148 on a continuous basis (e.g., every 2 seconds or other appropriate time period). The network data 454 may include, for example, RTT and/or RSSI measurements of one or more wireless signals received from one or more AP devices by UE 400 as measured by the AP devices.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 includes a receiver 432 and a transmitter 434. Wired interface 430 may be used, if desired, to couple UE 400 to network(s) 134 of FIG. 1. First, second and third wireless interfaces 420A, 420B, and 420C include receivers 422A, 422B, and 422C, respectively, each including a receive antenna via which UE 400 may receive wireless signals from wireless communications devices, such as AP devices 142 of FIG. 1, AP device 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as AP devices 142 of FIG. 1, AP device 200 of FIG. 2, other UEs 148 and/or other devices configured for wireless communication. In some examples, first wireless interface 420A may include a Wi-Fi 802.11 interface (e.g., 2.4 GHz and/or 5 GHZ) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming modules and/or data associated with operation of UE 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 includes an operating system 440, applications 442, a communications module 444, configuration settings 450, and data storage for network data 454. Data storage for network data 454 may include, for example, a status/error log including network data specific to UE 400. As described above, network data 454 may include any network data, events, and/or states that may be related to determination of one or more roaming quality assessments. The network data may include event data such as a log of normal events and error events according to a logging level based on instructions from the network management system (e.g., NMS 150/300). Data storage for network data 454 may store any data used and/or generated by UE 400, such as network data used to determine proximity to a proximity zone, which is collected by UE 400 and transmitted to any of AP devices 142 in a wireless network 106 for further transmission to NMS 150.

Communications module 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C.

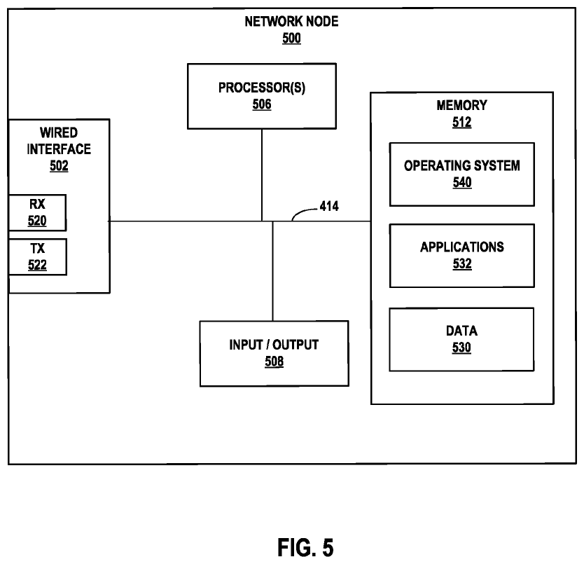

FIG. 5 is a block diagram illustrating an example network node 500 configured according to the techniques described herein. In one or more examples, the network node 500 implements a device or a server attached to the network 134 of FIG. 1, e.g., router, switch, AAA server 110, DHCP server 116, DNS server 122, VNA 133, AP location module 135, Web server 128A-128X, etc., or a network device such as, e.g., routers, switches or the like.

In this example, network node 500 includes a communications interface 502, e.g., an Ethernet interface, a processor 506, input/output 508, e.g., display, buttons, keyboard, keypad, touch screen, mouse, etc., a memory 512 and an assembly of components 516, e.g., assembly of hardware module, e.g., assembly of circuits, coupled together via a bus 509 over which the various elements may interchange data and information. Communications interface 502 couples the network node 500 to a network, such as an enterprise network.

Though only one interface is shown by way of example, those skilled in the art should recognize that network nodes may have multiple communication interfaces. Communications interface 502 includes a receiver 520 via which the network node 500 can receive data and information (e.g., including data indicative of distances between APs, and/or operation related information such as registration request, AAA services, DHCP requests, Simple Notification Service (SNS) look-ups, and Web page requests). Communications interface 502 includes a transmitter 522, via which the network node 500 can send data and information (e.g., including location information, configuration information, authentication information, web page data, etc.).

Memory 512 stores executable software applications 532, operating system 540 and data/information 530. Data 530 includes system log and/or error log that stores network data and/or proximity information for node 500 and/or other devices, such as wireless access points, based on a logging level according to instructions from the network management system. Network node 500 may, in some examples, forward the network data to a network management system (e.g., NMS 130 of FIG. 1) for analysis as described herein.

FIG. 6 is a diagram of an example multipath wireless environment including line of sight (LOS) and non-line of sight (NLOS) signal paths. Multipath occurs when a transmitted signal is reflected, scattered, or otherwise diverted from a direct LOS path to one or more NLOS paths between the transmitter and receiver. The NLOS paths are longer than the LOS path and thus also have a longer propagation time. The LOS and NLOS signals arrive at the receiver by different and distinct paths and at different times due to the different path lengths. The distance along the NLOS path is longer than the real distance/path between the transmitter and the receiver. Therefore, if an incorrect (i.e., longer) path length is used to estimate locations of one or more devices in a wireless network, the location estimates may be erroneous

In environments when a signal travels from a transmitting antenna 602A of a first access point (AP) 620A to a receiving antenna 602B of a second AP 620B, a portion of the signal 610 travels in a straight line (i.e., direct line of sight or LOS), and some of the signal, such as signal 612 is reflected by objects, such as walls 608, floors, or other objects, and bounce toward the receiving antenna 602B. Since these latter signals do not travel straight from the transmitter to the receiver, the paths are referred to as non-line of sight or NLOS. In most environments, a received signal is a combination of the LOS signal and one or more NLOS signals. For purposes of the present disclosure, the NLOS signals are described as being reflected by objects in the environment, however, in some examples the NLOS signals are also affected by scattering, diffraction, refraction, and/or other interactions with objects in the environment, and the disclosure is not limited in this respect.

In some wireless networking applications, the distance between two APs in the wireless network can be determined using RTT measurements and/or RSSI measurements of signals communicated between two APs. The RTT and/or RSSI measurements are indicative of the distance between the two APs.

While a LOS signal is a good indicator of the distance between the two APs (the LOS signal path being a straight line between the two APs), the NLOS portion of a multipath signal corrupts the distance measurements (e.g., RTT and/or RSSI measurements) by including the timing and/or power of the NLOS signals in the RTT and/or RSSI measurement(s). In other words, because the NLOS signal(s) take a longer path from the transmitting AP to the receiving AP, the contribution of the NLOS signal(s) to the received signal can result in inaccuracies in the distance measurements based on the RTT and/or RSSI of the received signals.

In the example illustrated in FIG. 6, because some of the received signal includes also signal 612, which is reflected by the wall 608, the measured RTT may be slightly larger than the actual LOS RTT resulting in an overestimation of the distance d. For example, the distance may be determined to be d+δ 616 instead of actual distance d 614. Similarly, the RSSI along the LOS path 610 corresponds to the distance d between the transmitting antenna 602A and the receiving antenna 602B. However, because some of the received signal includes also signal 612, which is reflected by the wall 608, the measured RSSI may be slightly larger than the actual LOS RSSI resulting in an under estimation of the distance d 614. For example, the distance may be determined to be d-Δ 618.

In accordance with one or more techniques of the disclosure, RTT/RSSI information alone may be used to determine an amount of multipath present in a received wireless signal. In some examples, the amount of multipath in a wireless signal is determined by collecting samplings of RTT/RSSI signals and averaging all the samples to get a better estimate, as further described below.

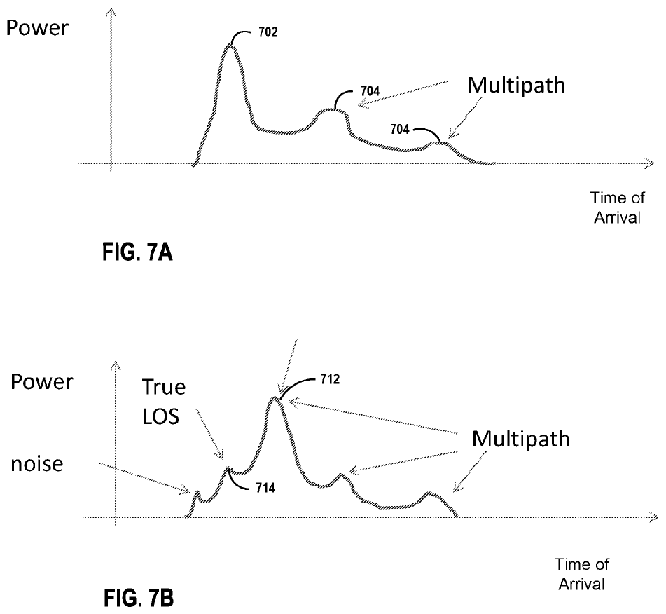

FIG. 7A illustrates an example of RTT estimation in a specific environment wherein the signal travels via a LOS path 610 and NLOS path 612 of FIG. 6. In this example the signal that travels via the LOS is the strongest received signal 702. Generally, RTT is estimated based on the strongest peak of the signal. While the received signal also exhibits some power due to multipath, peaks 704 corresponding to multipath are not as strong and are highly unlikely to be selected for distance estimation purposes. In other words, in this example, the system is able to determine the right LOS component and properly estimate the RTT of signal that travels along the LOS path 610.

FIG. 7B illustrates another example of RTT estimation in a specific environment wherein the signal travels via a LOS path 610 and NLOS path 612. In the example illustrated in FIG. 7B, the signal that travels via the NLOS path 612 is the strongest signal 712. This signal 712 may have a significant power peak due to noise and multipath. On the other hand, the signal 714 traveling along the LOS path 610 may be greatly attenuated and thus may exhibit a lower power peak as compared to the strongest signal 712. In this case, the system may perform erroneous estimation of the distance d based on the strongest signal 712.

Generally, RTT calculations may be carried by the hardware and firmware of the Wi-Fi access point (typically at the MAC layer). Raw RTT may be estimated based on the time it takes the signal to travel from the transmitting antenna 602A to the receiving antenna 602B and back. In accordance with one or more techniques of the disclosure, the raw RTT estimations may be processed to produce a better (e.g., less noisy) estimation. For example, a given number (N) samples of RTT may be averaged to produce an estimation of RTT.

In addition, in accordance with one or more techniques of the disclosure, the spread of RTT estimates may be calculated. In one non-limiting example, the spread of RTT estimates may be calculated as the root mean squared (RMS) deviation of the RTT measurements. It should be noted that calculation of the spread of RTT estimates is not limited to calculating RMS deviation of RTT measurements. In other aspects, other statistical measures, such as, but not limited to, variance, standard deviation, average Euclidian distance between RTT measurements, range, entropy, and the like may be used to determine the spread of RTT estimates.

According to aspects of the present disclosure, there is a polynomial relationship between the estimate errors that multipath signals introduce to the RTT measurements and the statistical spread of the RTT. This relationship is represented by the equation (1):

$$E = a * {S}^{⋀} 4 + b , \qquad ( 1 )$$

where:
E represents the predicted error in RTT estimates;
S represents a spread of the RTT values (e.g., RMS deviation of the RTT measurement); and
a and b are coefficients.
   Equation 1 may be used, for example, to determine a prediction for RTT error, represented by coefficients a, b, based on an input of the statistical spread S.

The polynomial equation provided above is just one example, and may use other polynomial equations, such as a polynomial with varying degrees based on the spread function used (e.g., variance, standard deviation, etc.). For example, a polynomial with a degree of two may be used if the spread function is variance or a polynomial with a degree of four may be used if the spread function is standard deviation. It is appreciated that the polynomial equation may refer to any type of polynomial.

In accordance with one or more techniques of the disclosure, at first, measurements may be taken in a controlled environment. Table 1 below illustrates RTT measurements taken in a controlled environment, where the distances between the transmitting antenna 602A and the receiving antenna 602B are known:

TABLE 1

| | Calculated | Measured | Estimated | RTT | RTT |
|---|---|---|---|---|---|
| Distance | RTT | RTT | distance | Spread | Error |
| d1 | RTT1 | RTT′1, 1 | d′1, 1 | S1 | E′1, 1 |
| d1 | RTT1 | RTT′1, 2 | d′1, 2 | | E′1, 2 |
| d1 | RTT1 | RTT′1, 3 | d′1, 3 | | E′1, 3 |
| d2 | RTT2 | RTT′2, 1 | d′2, 1 | S2 | E′2, 1 |
| d2 | RTT2 | RTT′2, 2 | d′2, 2 | | E′2, 2 |
| — | | | — | | — |
| — | | | — | | — |
| dn-1 | RTTn-1 | RTT′n-1, 1 | d′n-1, 1 | Sn-1 | E′n-1, 1 |
| dn-1 | RTTn-1 | RTT′n-1, 2 | d′n-1, 2 | | E′n-1, 2 |
| dn | RTTn | RTT′n, 1 | d′n, 1 | Sn | E′n, 1 |
| dn | RTTn | RTT′n, 2 | d′n, 2 | | E′n, 2 |
| dn | RTTn | RTT′n, 3 | d′n, 3 | | E′n, 3 |

Multiple measurements may be performed at each known distance d between the transmitting antenna 602A and the receiving antenna 602B. In an aspect, these multiple measurements may be performed using a different multipath pattern for each. For example, three measurements shown in Table 1 were performed for known distance d1 and corresponding calculated round trip measurements may be RTT1. In the example illustrated in Table 1, the actual measured RTT for three different multipath patterns are RTT′1, 1; RTT′1,2; and RTT′1,3. The RTT spread SI may be calculated using these actual measured RTT values. It should be noted that even though only three measurements are shown in Table 1, the techniques of the present disclosure could encompass much larger number of samples to obtain a better result. Any of the interpolation filters described herein can be of various sizes.

In addition, techniques of the present disclosure include a determination of the RTT error between the calculated RTT and the measured RTT. Such RTT errors may be calculated using equation (2):

$${E}_{k} = {RTT}_{k , n}^{’} - {RTT}_{k} , \qquad ( 2 )$$

where:
   RTT′_{k,n} represents measured RTT values; and
   RTTₖ represents calculated RTT values.

Last column in Table 1 illustrates calculated RTT errors for each performed measurement (e.g., E′1,1; E′1,2; and E′1,3).

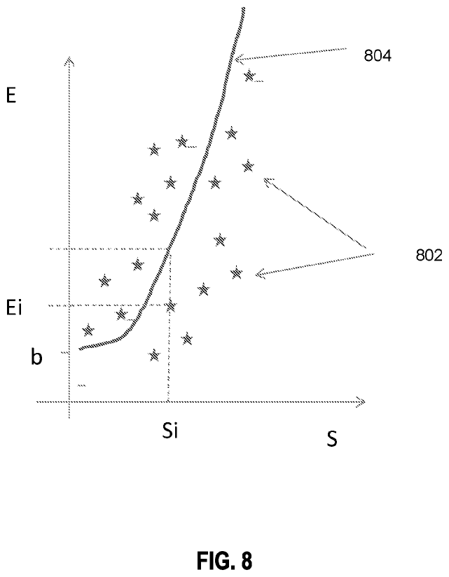

FIG. 8 is a graph illustrating an example of RTT errors as a function of the spread. Corresponding points 802 (each having corresponding E and S values) are taken from the Table 1. In accordance with one or more techniques of the disclosure, a curve-fitting algorithm may be used to fit the polynomial curve 804 (such as the curve provided by equation (1)) to the points 802 shown in FIG. 8. For example, a curve-fitting algorithm may attempt to fit a curve corresponding to the equation (2). It should be noted that polynomial equations are presented here for illustrative purposes only. Techniques of the present disclosure contemplate usage of other polynomial equations. The curve-fitting algorithm may include, but is not limited to a polynomial regression, superellipse curve fit, generalized Hough transform, or other curve-fitting approaches.

More specifically, the curve fitting algorithm may be used to determine the coefficients a and b such as to minimize the sum of errors between the polynomial curve and the actual measured RTT numbers presented in the Table 1. For example, the curve fitting algorithm may utilize equations (3)-(5) shown below:

$$Min {\sum }_{i = 1}^{n} {Error}^{2} = Min {\sum }_{i = 1}^{n} {( ( a * {Si}^{4} + b ) - Ei )}^{2} \qquad ( 3 )$$

Next, the derivative of equation (3) may be taken with respect to a and the derivative may be equated to zero, which leads to equation (4).

$$\frac{\partial }{\partial a} {\sum }_{i = 1}^{n} {( ( a * {Si}^{4} + b ) - Ei )}^{2} = {\sum }_{i = 1}^{n} 2 ( ( a * {Si}^{4} + b ) - Ei ) * {Si}^{4} ) = 0 \qquad ( 4 )$$

Similarly, the derivative of equation (3) may be taken with respect to b and the derivative may be equated to zero, which leads to equation (5).

$$\frac{\partial }{\partial b} {\sum }_{i = 1}^{n} {( ( a * {Si}^{4} + b ) - Ei )}^{2} = {\sum }_{i = 1}^{n} 2 ( ( a * {Si}^{4} + b ) - Ei ) = 0 \qquad ( 5 )$$

According to techniques in the present disclosure, the curve fitting algorithm may determine coefficients a and b by solving equations (4) and (5). Once coefficients a and b are determined, these coefficients may be used to correct the measured RTT values. To correct the measured RTT values, the same spread of the RTT values used to determine coefficients a and b may be calculated. Then using that value alongside a and b, the error in the RTT value may be predicted. Next, the predicted error may be subtracted from the RTT distance estimates.

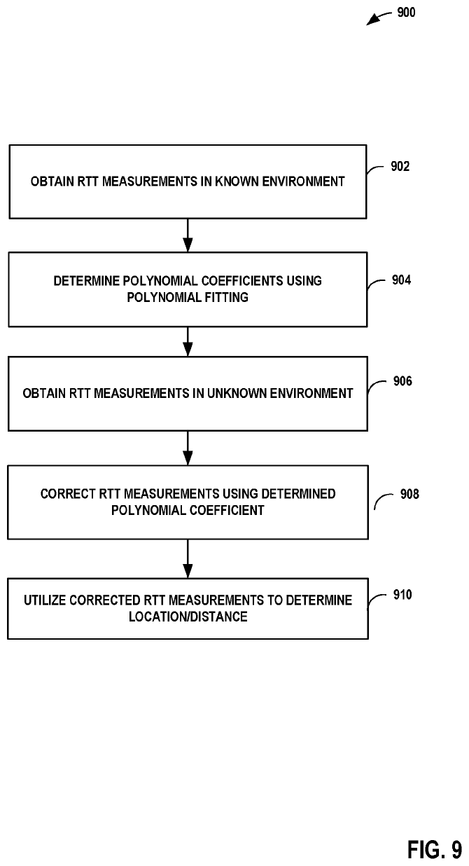

FIG. 9 is a flowchart of an example process (900) by which a computing device corrects the measured RTT/RSSI values using the spread in distance measurements, in accordance with one or more techniques of the disclosure. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B. In addition, although process (900) is described as being executed out by NMS 130/300, any computing device or group of computing devices, such as any one or more of APs 142/200, servers 128, edge computing devices 150, network node 500, etc., may execute the functions described herein, and the disclosure is not limited in this respect.

The computing device may obtain measurements in known environment (902). For example, the computing device may obtain measurements in the environment where the distance d between the transmitting antenna 602A of a first AP device 620A and the receiving antenna 602B of a second AP device 620B is known. The computing device may obtain distance measurements, such as RTT measurements and/or RSSI measurements. At 904, the computing device may next determine coefficients a and b of a polynomial using, for example, a polynomial fitting algorithm described above in conjunction with equations (3), (4), and (5). Once coefficients a and b determined, the described system may use the determined coefficients to correct distance measurements of an unknown environment.

At 906, the computing device may obtain RTT/RSSI measurements in unknown environments. For example, the computing device may obtain distance measurements in the environment where the distance d between the transmitting antenna of a third AP device and the receiving antenna of a fourth AP device is unknown.

At 908, the computing device utilizes the coefficients determined at 904 to correct the RTT/RSSI measurements obtained at 906. To correct the measured RTT values, the same spread of the RTT values used to determine coefficients a and b may be calculated. Then using that value alongside a and b, the error in the RTT value may be predicted. Next, the predicted error may be subtracted from the RTT distance estimates. At 910, the computing device uses the corrected RTT measurements to determine a more precise distance between the transmitting antenna 602A and the receiving antenna 602B. In one non-limiting example, the corrected RTT measurements may be used in estimation of the location of a Wi-Fi device. Example techniques for automatically determining locations (e.g., coordinates) of deployed APs based on distance measurements between APs are described in U.S. Provisional Patent Application No. 63/243,616, filed Sep. 13, 2021, and entitled “Determining Locations of Deployed Access Points;” which is incorporated by reference herein in its entirety.

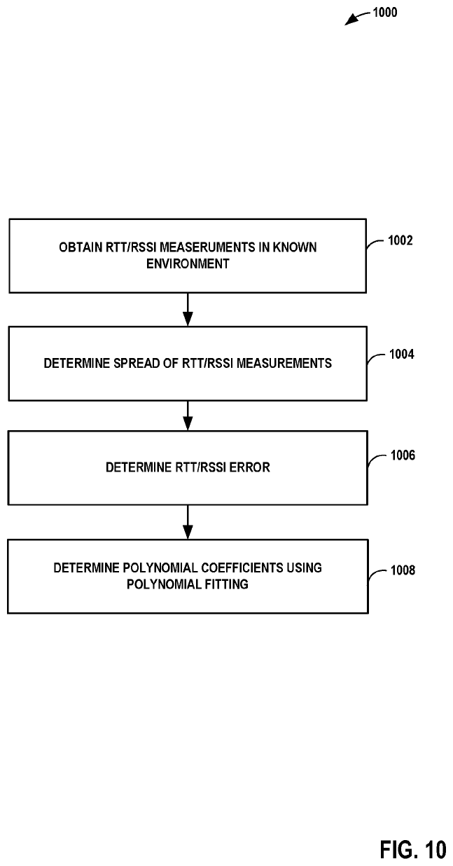

FIG. 10 is a flowchart of an example process (1000) by which a computing device determines coefficients of the correction polynomial, in accordance with one or more techniques of the disclosure. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B In addition, although process (1000) is described as being executed out by NMS 130/300, any computing device or group of computing devices, such as any one or more of APs 142/200, servers 128, edge computing devices 150, network node 500, etc., may execute the functions described herein, and the disclosure is not limited in this respect. Process 1000 of FIG. 10 may provide, as one example, greater detail of steps 902 and 904 of process 900.

The computing device may obtain distance (RTT/RSSI) measurements in known environment (1002). For example, the computing device may obtain measurements in the environment where the distance d between the transmitting antenna 602A of a first AP device 620 and the receiving antenna 602B of a second AP device 620B is known. In some examples, the computing device may obtain RTT measurements collected over a selected period of time (e.g., one hour). In some examples, the computing device may obtain RTT measurements and/or RSSI measurements.

At 1004, the computing device may determine a spread of obtained RTT/RSSI measurements. In one non-limiting example, the spread of RTT estimates may be calculated as the root mean squared (RMS) deviation of the RTT measurements. It should be noted that calculation of the spread of RTT/RSSI estimates is not limited to calculating RMS deviation of RTT/RSSI measurements. In other aspects, other statistical measures, such as, but not limited to variance, standard deviation, average Euclidian distance between RTT/RSSI measurements, range, entropy and the like may be used to determine the spread of RTT/RSSI estimates.

At 1006, the computing device may determine an error between the calculated RTT/RSSI values (based on known distance) and the obtained RTT/RSSI measurements. Such RTT/RSSI errors may be calculated using, for example, equation (2) shown above. As noted above, there is a polynomial relationship between the errors that multipath signals introduce to the RTT/RSSI measurements and the statistical spread of the RTT/RSSI measurements. As one example, such polynomial relationship is described by equation (1). Accordingly, at 1006, the computing device may approximate the spread of measured RTT/RSSI values and the determined RTT/RSSI errors by a polynomial.

At 1008, the computing device may determine coefficients of the polynomial (e.g., coefficients a and b) by performing, for example, the curve-fitting algorithm described by equations (3), (4), and (5) above.

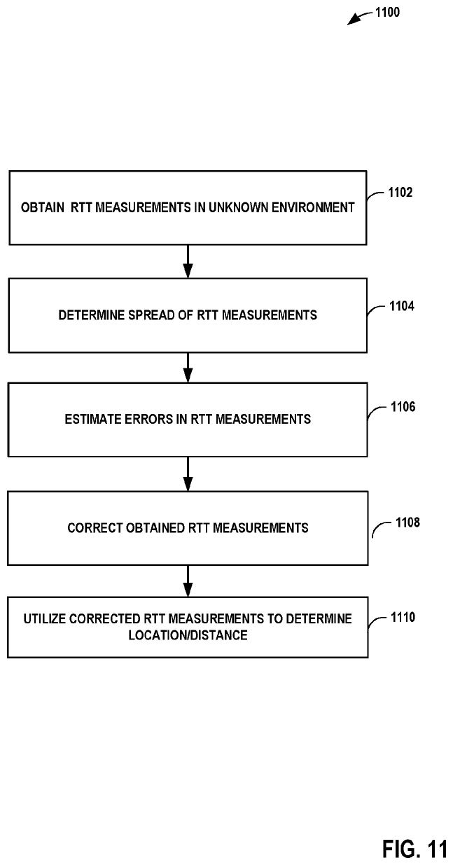

FIG. 11 is a flowchart of an example process (1100) by which a computing device reduces errors introduced by multipath in the RTT measurements, in accordance with one or more techniques of the disclosure. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B. In addition, although process (1100) is described as being executed out by NMS 130/300, any computing device or group of computing devices, such as any one or more of APs 142/200, servers 128, edge computing devices 150, network node 500, etc., may execute the functions described herein, and the disclosure is not limited in this respect. Process 1100 of FIG. 11 may provide, as one example, greater detail of steps 906, 908, and 910 of process 900.

The computing device may obtain RTT measurements in unknown environment (1102). For example, the computing device may obtain measurements in the environment where the distance d between the transmitting antenna 602A and the receiving antenna 602B is unknown. The computing device may obtain RTT measurements collected over a selected period of time (e.g., one hour)

At 1104, the computing device may determine a spread of obtained RTT measurements. In one non-limiting example, the spread of RTT measurements may be calculated as the root mean squared (RMS) deviation of the RTT measurements. It should be noted that calculation of the spread of RTT measurements is not limited to calculating RMS deviation of RTT measurements. In other aspects, other statistical measures, such as, but not limited to variance, standard deviation, average Euclidian distance between RTT measurements, range, entropy, and the like may be used to determine the spread of RTT measurements.

At 1106, the computing device may estimate errors in the RTT measurements by approximating the spread of obtained RTT measurements by a polynomial and by determining coefficients of the polynomial (e.g., coefficients a and b of equation (1)) by performing the curve-fitting algorithm described in equations (3), (4), and (5) above.

At 1108, the computing device may use the estimated RTT errors to correct the obtained RTT measurements. According to techniques in the present disclosure, the computing device may calculate the corrected RTT measurements using equation (6) shown below:

$$Corrected RTT measurement = Measureed RTT - Estimated RTT error \qquad ( 6 )$$

As noted above there is a polynomial relationship between the errors that multipath introduces to the RTT measurements and the statistical spread of the RTT that is defined by equation (1).

At 1110, the computing device may use the corrected RTT measurements, for example, to determine locations of one or more devices in a wireless network. In one non-limiting example, the corrected RTT measurements may be used to determine a distance between the transmitting antenna of a device and the receiving antenna of another device.

Although process (1100) is described with respect to correcting RTT measurements, the same process can be used for correcting other Wi-Fi related measurements such as, but not limited to RSSI. In one aspect, the computing device may use corrected RTT measurements for improving accuracy of determining the location of one or more devices in the wireless network. In another aspect, the computing device may use the estimated RTT errors to identify isolated Aps (IAPs) for which there is no set of LOS RTT measurements between these IAPs and their neighbors. Since there are no set LOS RTT measurements between the IAPs and their neighbors, the determination of the location of IAP based on the locations of their neighbors may be prone to errors. Similarly, the determination of the locations of the neighbors of an IAP based on the RTT measurements between the IAPs and its neighbors may also be prone to errors.

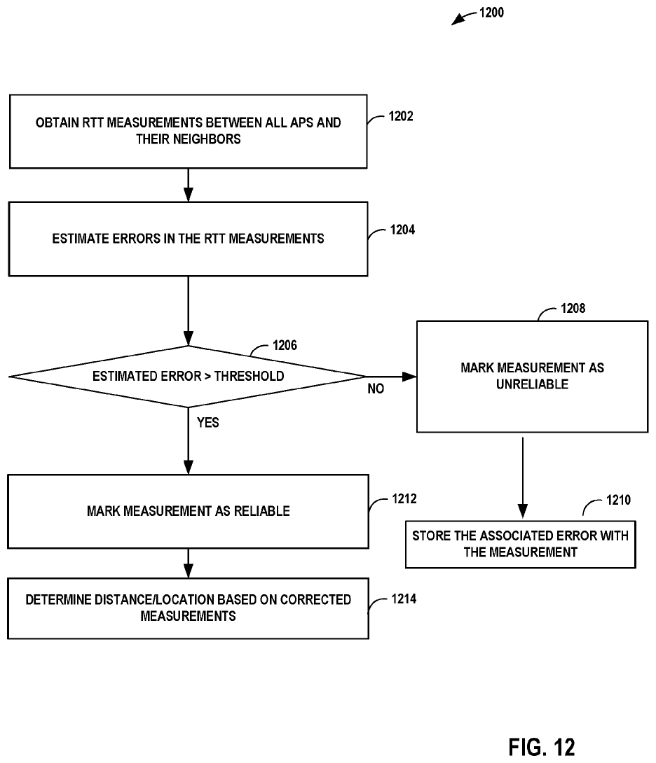

FIG. 12 is a flowchart of an example process (1200) by which a computing device uses the estimated RTT errors for determining which RTT measurements provide reliable means for determining the distance between the transmitting antenna of a device and the receiving antenna of another device, in accordance with one or more techniques of the disclosure. In addition, the process 1200 may be used by the computing device for determining whether the measured RTT measurements provide reliable means for determining the distance between two neighboring APs. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B. In addition, although process (1200) is described as being executed out by NMS 130/300, any computing device or group of computing devices, such as any one or more of APs 142/200, servers 128, edge computing devices 150, network node 500, etc., may execute the functions described herein, and the disclosure is not limited in this respect.

At 1202, the computing device may obtain RTT measurements between all APs and their neighbors. For the sake of simplicity, the process 1200 is described with respect to only one AP.

At 1204, the computing device may determine a spread of obtained RTT measurements. In one non-limiting example, the spread of RTT measurements may be calculated as the root mean squared (RMS) deviation of the RTT measurements. It should be noted that calculation of the spread of RTT measurements is not limited to calculating RMS deviation of RTT measurements. In other aspects, other statistical measures, such as, but not limited to variance, standard deviation, average Euclidian distance between RTT measurements, range, entropy and the like may be used to determine the spread of RTT measurements. Furthermore, at 1204, the computing device may estimate errors in the RTT measurements by approximating the spread of obtained RTT measurements by a polynomial and by determining coefficients (e.g., coefficients a and b) of the polynomial by performing the curve-fitting algorithm described above.

At 1206, the computing device may determine whether the estimated error in the RTT measurements is greater than a predetermined threshold. If the estimated error is greater than the predetermined threshold (YES branch), the computing device may mark the corresponding RTT measurement as unreliable (1208). At 1210, the computing device may store the estimated error along with the corresponding RTT measurement.

In accordance with one or more techniques of the disclosure, rather than tagging the RTT measurement as unreliable at 1208, the computing device may use the estimated error to correct the measurement, using equation (6), for example. The computing device may use the corrected measurement to determine the distance between the transmitting antenna 602A and the receiving antenna 602B.

However, if the estimated error is not greater than the predetermined threshold (NO branch), the computing device may mark the corresponding RTT measurement as reliable (1212). It should be noted that the computing device may store the estimated error along with the corresponding RTT measurement. This step is not shown in FIG. 12 for the sake of simplicity. At 1214, the computing device may utilize the accurate and reliable RTT measurement, for example, to determine the distance between the transmitting antenna 602A and the receiving antenna 602B. In accordance with one or more techniques of the disclosure, the computing device may utilize the accurate and reliable RTT measurement to determine the distance between two neighboring APs.

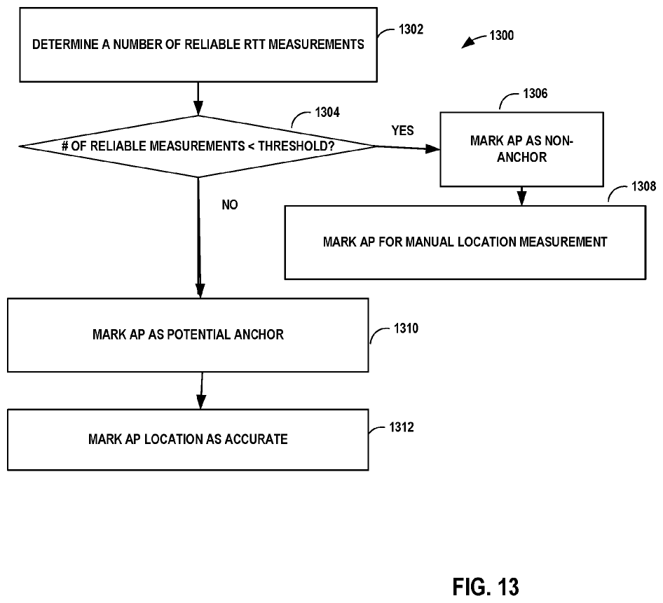

FIG. 13 is a flowchart of an example process (1300) by which a computing device uses the estimated RTT errors for determining which APs can be used as anchor APs, in accordance with one or more techniques of the disclosure. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B. In addition, although process (1300) is described as being executed out by NMS 130/300, any computing device or group of computing devices, such as any one or more of APs 142/200, servers 128, edge computing devices 150, network node 500, etc., may execute the functions described herein, and the disclosure is not limited in this respect.

At 1302, the computing device may determine a number of reliable RTT measurements between an AP and its neighbors, as described above in conjunction with the process 1200.

At 1304, the computing device may determine whether the number of reliable RTT measurements is smaller than a predetermined threshold. In one non-limiting example, the predetermined threshold may be equal to 3. In response to determining that the number of reliable RTT measurements is smaller than the predetermined threshold (YES branch), the computing device may mark the corresponding AP as not suitable to be served as an anchor AP (1306). In addition, at 1308, the computing device may tag the corresponding AP for potentially manual location determination by a technician because an automatic location estimation may be inaccurate due to inaccurate measurements data.

However, in response to determining that the number of reliable RTT measurements is not smaller than the predetermined threshold (NO branch), the computing device may mark the corresponding AP as suitable to be served as an anchor AP used to determine the location of neighboring APs from the anchor AP (1310). In addition, at 1312, if the location of AP is determined based on locations of its neighbors, the computing device may tag the corresponding AP as having a small location error. It should be noted that the computing device may tag the corresponding AP with its respective location error.

FIG. 14A is a diagram of an example multipath wireless environment including line of sight (LOS) and non-line of sight (NLOS) signal paths Multipath occurs when a transmitted signal is reflected, scattered, or otherwise diverted from a direct line of sight (LOS) path to one or more non line of sight (NLOS) paths between the transmitter and receiver. The NLOS paths are longer than the LOS path and thus also have a longer propagation time. The LOS and NLOS signals arrive at the receiver by different and distinct paths and at different times due to the different path lengths. The distance along the NLOS path is longer than the real distance/path between the transmitter and the receiver. Therefore, if an incorrect (i.e., longer) path length is used to estimate locations of one or more devices in a wireless network, the location estimates may be erroneous.

In real environments when a signal travels from a transmitting antenna 1402A of a first access point (AP) 1420A to a receiving antenna 1402B of a second AP 1420B, a portion of the signal 1410 travels in a straight line (i.e., direct line of sight or LOS), and some of the signal, such as signals 1412A, 1412B, and 1412C, are reflected by objects such as walls 1408, floors or other objects 1406A, 1406B and bounce toward the receiving antenna 1402B. Since these latter signals do not travel straight from the transmitter to the receiver, the paths are referred to as non-line of sight or NLOS. In most real environments, a received signal is a combination of the LOS signal and one or more NLOS signals. For purposes of the present disclosure, the NLOS signals are described as being reflected by objects in the environment, however, in some examples the NLOS signals are also affected by scattering, diffraction, refraction, and/or other interactions with objects in the environment, and the disclosure is not limited in this respect.

In some wireless networking applications, the distance between two APs in the wireless network can be determined using round-trip time (RTT) measurements and/or received signal strength indicator (RSSI) measurements of signals communicated between two APs. The RTT and/or RSSI measurements are indicative of the distance between the two APs.

While a LOS signal is a good indicator of the distance between the two APs (the LOS signal path being a straight line between the two APs), the NLOS portion of a multipath signal corrupts the distance measurements (e.g., RTT and/or RSSI measurements) by including the timing and/or power of the NLOS signals in the RTT and/or RSSI measurement(s). In other words, because the NLOS signal(s) take a longer path from the transmitting to the receiving AP, the contribution of the NLOS signal(s) to the received signal can result in inaccuracies in the distance measurements based on the RTT and/or RSSI of the received signals.

In accordance with one or more techniques of the disclosure, channel state information (CSI) is used to determine an amount of multipath present in a received wireless signal. In some examples, the amount of multipath in a wireless signal is determined based on amplitude and/or phase information in the CSI information obtained for the wireless signal over a period of time. For example, the amount of multipath in a wireless signal transmitted between two APs may be used as an indication of the relative accuracy of a corresponding distance measurement (e.g., RTT and/or RSSI measurements) based on that wireless signal that is indicative of a distance between the two APs. The amount of multipath in the wireless signal is compared to a threshold. In some examples, distance measurements based on signals transmitted between two APs having less than the threshold amount of multipath are used to calculate a distance between the two APs, whereas distance measurements based on signals having more than the threshold amount of multipath are not used in the distance calculation. In other examples, distance measurements based on signals transmitted between two APs having more than the threshold amount of multipath are corrected based on one or more error correction factor corresponding to the amount of multipath present in the signal. The corrected distance measurements may then be used to calculate the distance between the two APs. In some examples, the determination of the amount of multipath present in the signal is expressed as a percentage of the signal that is affected by multipath and/or one or more error correction factor(s) corresponding to the amount of multipath.

CSI is a complex vector (I/Q data) which contains amplitude and phase information about the propagation channel at specific subcarrier frequencies for each pair of transmit and receive antennas. FIG. 14B is a diagram of an example time series of CSI vector sample. The time series of CSI 1430 of a received wireless signal, CSI_{i,j}, where i is the transmitting AP and j is the receiving AP, may be represented as a collection of vectors 1432 of 2×n values wherein the first column represents amplitude (A), the second column represents the phase (α) of the corresponding amplitude measurement, and n is the number of channels for which CSI measurements are acquired. The CSI vector 1432 is measured (sampled) periodically at times t1, t2, . . . , etc. Each AP 142/200 samples the CSI vector of signals received from one or more transmitting APs and stores the CSI vectors as, for example, CSI data 139, 254, 319 as shown in FIGS. 1, 2, and 3. An AP 142/200 may further determine distance measurements indicative of a distance between the AP and one or more other APs in the wireless network based on wireless signals communicated between the two APs. The distance measurements may include, for example, RTT and/or RSSI measurements indicative of the distance between two APs. The distance measurements may be stored as, for example, RTT/RSSI data 143, 252, 325 as shown in FIGS. 1, 2, and 3. Each AP periodically transmits the CSI and/or RTT/RSSI data to a computing device, such as NMS 130/300 as shown in FIGS. 1A, 1B and 3 or other computing device configured to process the CSI and/or RTT/RSSI data. NMS 130/300 or other computing device stores the CSI data received from the APs as CSI data 139/319 and RTT/RSSI data received from the APs as RTT/RSSI data 143/325. In some examples, the CSI samples are collected and analyzed over one or more sample periods. In some examples, the CSI data is relatively stable within intervals of 10-100 msec, so averaging CSI samples over those intervals may help to reduce noise.

In some examples, an amount of multipath in a received signal is determined based on a distribution of the phase of the CSI samples over a period of time. For example, a computing device, such as NMS 130/300 or other computing device executing deployed AP location module 372, determines a portion, e.g., a “percentage” of the received signal due to multipath based on a histogram of the phase values of the CSI vectors acquired over a period of time.

In general, the amount of energy in the signal due to multipath (e.g., the percentage of multipath) is not necessarily indicative of the absolute number of NLOS signals. Rather, the contributions to the amount of energy in the signal due to multipath may from (1) a large number of NLOS signals that each contribute a relatively smaller amount to the determined percentage of multipath or (2) a smaller number of NLOS signal that each contribute a relatively larger amount to the determined percentage of multipath. Both scenarios can result in RTT/RSSI measurements having a large degree of error in the associated distance determination.

In accordance with one or more techniques of the disclosure, it has been determined that LOS conditions (i.e., relatively lesser amount of multipath) are associated with relatively greater variation in the phase histogram offset, and NLOS (relatively greater amount of multipath) conditions are associated with relatively lesser variation in the phase histogram offset. Thus, in some examples, RTT/RSSI measurements used to determine distances between APs in a wireless network are selected based on the amount of multipath or phase histogram variance of the underlying wireless signals. In other examples, the amount of multipath or phase histogram variance of wireless signals transmitted between APs in a wireless network is indicative of whether an AP is an “outlier” AP. In other examples, the amount of multipath or phase histogram variance of wireless signals transmitted between wireless devices (such as APs) in a wireless network determined based on CSI information as described herein may be used for purposes of radio resource management (RRM) in order to learn and optimize the RF environment provided by the wireless network. The determination of the amount of multipath in wireless signals based on a phase histogram variance in accordance with the techniques of the disclosure may also be applicable to other use cases for purposes of monitoring and management of wireless networks, and the disclosure is not limited in this respect.

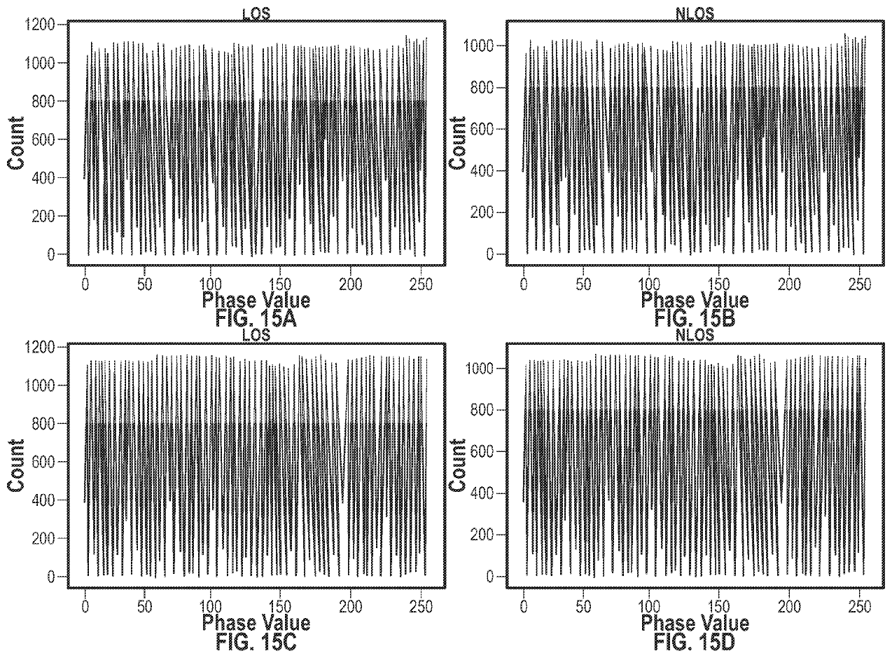

FIGS. 15A-15D are histograms of the counts of a particular phase value (or bin of phase values in this example) (y-axis) versus the phase values themselves (x-axis) over a predetermined period of time (e.g., 30 minutes, 1 hour, etc.). The number of times a specific phase value was measured (experienced) is indicated by the y-axis and the specific phase value is indicated on the x-axis. The measurements which are indicated in the figures correspond to measurements from different locations; each line corresponds to a histogram of phase measurements in a specific location.

The CSI phase has a periodic pattern due to the fixed frequency at which new packets are received by an AP when CSI data is sampled. Due to greater variety in phase offset, under NLOS conditions, the values represented in the phase histograms (FIGS. 15B and 15D) exhibit a relatively lesser amount of variation, because the peaks are relatively lower and the troughs are relatively shallower, the total number of counts each phase value is more centralized around the mean value in each bin. When a substantial portion of the signal travels over the LOS path, the values represented in the phase histograms (FIGS. 15A and 15C) exhibit a relatively greater variation in the values of the measured phase histogram.

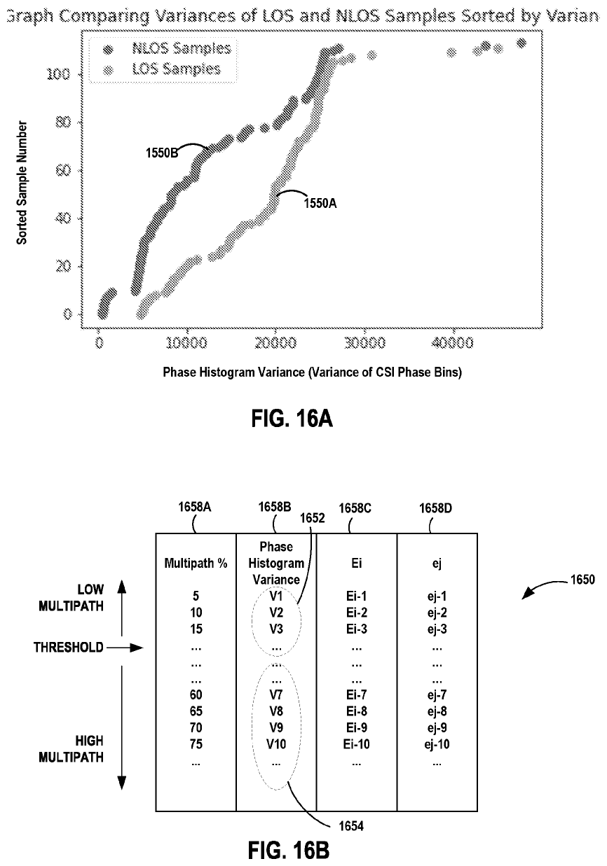

FIG. 16A is a graph of the variance of example CSI Phase values binned based on their value versus the sample location that data was collected from. This example data is sorted based on the variance of the values in the various CSI phase bins. In this example, the samples under LOS dominant conditions (curve 1550A) show a relatively greater variance of the values in the various CSI phase bins as compared to samples under NLOS dominant conditions (curve 1550B). This variation in the values in the various CSI phase bins in the phase histogram is referred to herein as “phase histogram variance.”

In accordance with one or more techniques of the disclosure, CSI data may be collected in conjunction with RTT/RSSI, etc., and relationship(s) determined between them. For example, the CSI data may be collected using controlled experiments or using estimates from the historical CSI data. CSI vectors for each of a plurality of multipath signals are sampled and a histogram of the CSI phases is generated. A variance for each CSI phase value (or bin of phase values) (i.e., “phase histogram variance”) is determined. In some examples, the RTT/RSSI distances determined based on the multipath signals are compared to the corresponding known (i.e., measured) distances to determine an error relationship associated with the amount of multipath in the NLOS signals. The resulting information can be stored in a data structure such as that shown in FIG. 16B. In general, the phase histogram variance has an inverse relationship to the amount of multipath present in the wireless signal. In other words, a relatively lesser phase histogram variance is indicative of a greater amount of multipath in the wireless signal, while a relatively greater phase histogram variance is indicative of a relatively lesser amount of multipath in the wireless signal. Therefore, in FIG. 16B, as the amount of multipath shown in the first column increases from the lower rows to the higher rows of table 1650, the phase histogram variance decreases from the lower rows to the higher rows of table 1650.

In some examples, the determination of the amount of multipath present in the signal is expressed as a percentage of the signal that is affected by multipath and/or an error correction factor corresponding to the amount of multipath. In FIG. 16B, for example, the amount of multipath in an NLOS signal is expressed as a percentage (shown in the first column 1658A of the table). This percentage is further associated with a phase histogram variance (variance in the values of the various CSI phase histogram bins) (second column 1658B) and/or one or more error correction factors (third and fourth columns 1658C and 1658D).

While the examples herein describe using CSI phase information to determine an amount of multipath, examples including use of CSI amplitude or a combination of CSI amplitude and phase information to determine the amount of multipath in a wireless signal are also contemplated, and the disclosure is not limited in this respect.

In some examples, machine learning techniques may be applied to determine an amount of multipath present in a wireless signal based on CSI information for the signal. For example, one or more classifier features may be applied as input to a machine learning model to classify the amount of multipath present in a wireless signal based on CSI information. Examples features may include, but are not limited to, frequency domain data such as amplitude data (e.g., mean, variance, skewness, kurtosis, Euclidean similarity, Pearson correlation, entropy, etc.) phase data (e.g., variance, amplitude weighted variance, etc.); and time domain data such as Channel Impulse Response (CIR) (e.g., mean, variance, skewness, kurtosis, Euclidean similarity, entropy, etc.). The channel(s) may be modeled using one or more channel models including, but not limited to, Rayleigh, Rician, Nakagami, etc.

A labeled dataset may be split into training feature data and testing feature data. Test feature data may be taken from different but similar environments to the training feature data. Data can also be generated synthetically. The classifier may include, for example, a Support Vector Machine (SVM) or other supervised machine learning model trained to classify whether there is an obstacle in the LOS path using the training feature data. This may be used to approximate whether the dominant path is a LOS or NLOS path. The classifier's accuracy may then be tested using the testing feature data set. Other examples may include estimating the degree of multipath or the time correction to the RSSI/RTT measurements.

Referring again to FIG. 16B, in accordance with one or more techniques of the disclosure, a configurable threshold is indicative of an amount of multipath present in the wireless signals. In some examples, the amount of multipath in a wireless signal corresponds to a variance in the values in the various CSI phase histogram bins (“phase histogram variance”). In some examples, a computing device, such as NMS 130/300 or other computing device executing deployed AP location module 372, determines an amount of multipath of a wireless signal based on a histogram of the CSI information for the wireless signal obtained over a period of time. The amount of multipath of the wireless signals is compared to the threshold. Measurements of wireless signals (e.g., RTT, RSSI, etc.) having less than the threshold amount of multipath may be considered to be “low multipath.” Measurements (e.g., RTT, RSSI, etc.) of such “low multipath” wireless signals may be determined to be sufficiently accurate for purposes of determining a distance between the two APs (or any other combination of two wireless devices) between which the wireless signal was transmitted. Wireless signals having more than the threshold amount of multipath may be considered to be “high multipath” and hence, distance measurements based on such high multipath wireless signals may be insufficiently accurate for purposes of determining a distance between the two APs.

For example, assume in FIG. 16B, that a threshold amount of multipath is set to correspond to the phase histogram variance, “V3.” Wireless signals having an amount of multipath less than (or equal to) the phase histogram variance threshold V3, e.g., phase histogram variance values V1, V2 and V3 as indicated by reference numeral 1652, would be considered acceptable for purposes of determining a distance based on the RTT/RSSI measurements corresponding to the wireless signal. Conversely, wireless signals having an amount of multipath greater than the phase histogram variance threshold V3 (e.g., phase histogram variance values 1654) would be considered less desirable or not acceptable for purposes of determining the distance between two APs based the RTT/RSSI measurements corresponding to the signal. In some examples, RTT/RSSI measurements based on signals transmitted between two APs having less than the threshold phase histogram variance are used to calculate a distance between the two APs, whereas RTT/RSSI measurements based on signals having more than the threshold phase histogram variance are not used in the distance calculation (e.g., they are ignored or discarded).

In some examples, RTT/RSSI measurements based on signals transmitted between two APs having more than the threshold amount of multipath are corrected based one or more error correction factor corresponding to the amount of multipath associated with the wireless signal. Example error correction factors El-Ei are shown in the third column of table 1650 as shown in FIG. 16B. The corrected RTT/RSSI measurements may then be used to determine the distance between the two APs. In some examples, a corrected (“actual”) distance may be determined according to the following equation:

$$Actual distance = {( Measured distance )}_{i} * {E}_{i} - {e}_{j} \qquad ( 8 )$$

where eⱼ is an additive error correction factor associated with the amount of multipath in the signal, and Eᵢ is a proportional correction factor associated with the amount of multipath in the signal.
Measured distance is based on a measurement of RTT and/or RSSI which are indicative of the distance between a transmitting and a receiving AP.

Although equation (7) is one example of determining a corrected distance, other equations or appropriate error correction techniques may also be used, and the disclosure is not limited in this respect.

In general, the error applied correction factor reduces the distance obtained from the measured RTT (based on the NLOS distance) because the error introduced into an RTT distance measurement based on a signal including multipath is additive due to the increased path lengths introduced by the NLOS signal paths.

In accordance with one or more techniques of the disclosure, in examples where distance measurements are selected based on the CSI data for wireless signals communicated between APs, when one or more distance measurements are ignored based on CSI information as described herein, one or more isolated islands of APs may be created for which there are not enough distance measurements to other APs having an amount of multipath less than the threshold value to enable their location to be determined accurately. In some examples, at least three distance measurements, and sometimes more than four distance measurements, to other APs are required in order to accurately determine the location of an AP by trilateration without the possibility of flip ambiguities or other localization errors. In some examples, when there are insufficient distance measurements having an amount of multipath less than a threshold value, the computing device may generate a notification including an indication that the one or more isolated islands of APs have been identified, including an identification of the specific AP(s), and/or a recommendation that manual measurements be taken for one or more of the identified APs for which there are not sufficient distance estimates to one or more APs in a main AP group.

In other examples, in accordance with one or more techniques of the disclosure, the amount of multipath in a wireless signal transmitted between two APs is indicative of whether an AP is an “outlier” AP, i.e., an AP that is relatively isolated with respect to other APs. This can be with respect to its geographic deployment and/or with respect to its ability to communicate with other APs in the wireless network. In other examples, the amount of multipath or phase histogram variance of wireless signals transmitted between wireless devices (such as APs) in a wireless network determined based on CSI information as described herein may be used for purposes of radio resource management (RRM) in order to learn and optimize the RF environment provided by the wireless network.

In accordance with one or more techniques of the disclosure, in some examples, if it is determined that one or more APs have been installed in a location associated with a high amount of multipath, the computing device may automatically generate a notification including a recommendation to move the one or more APs to different location(s) associated with a relatively lesser amount of multipath. In some examples, the computing device may automatically adjust the transmit power, channel, and/or operating frequency of one or more APs based on the determined amount of multipath for one or more APs.

In accordance with yet another example implementation, when needed, RTT/RSSI measurements taken over a path with a relatively greater amount of multipath are used in the determination of the location of a specific AP and the user is notified about the fact that the location of that AP may be considered to be less accurate.

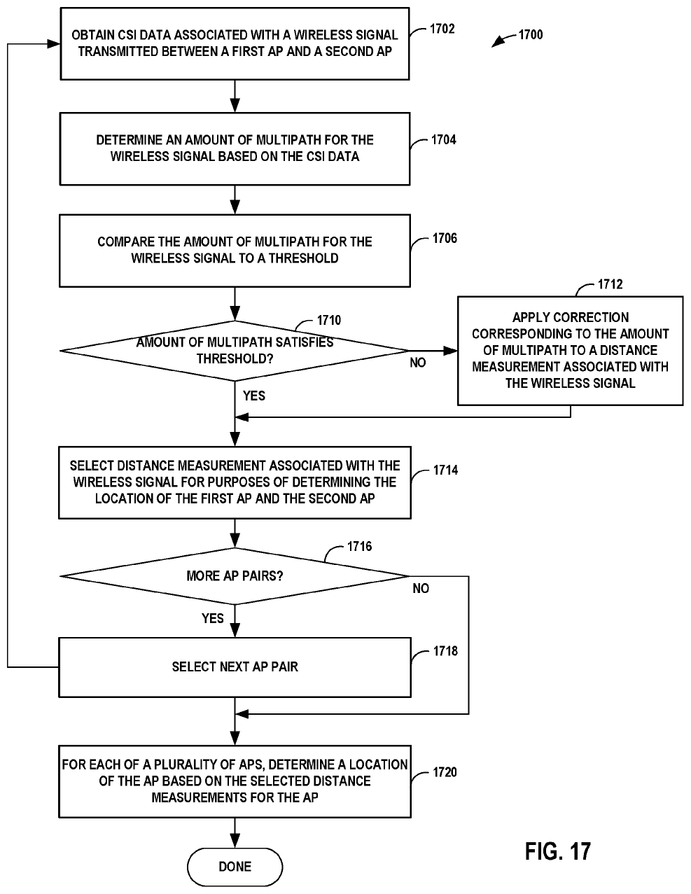

FIG. 17 is a flowchart of an example process (1700) by which a computing device selects distance measurements between APs based on CSI information and determines locations of the APs based on the selected distance measurements, in accordance with one or more techniques of the disclosure. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B. In addition, although process (1700) is described as being executed out by NMS 130/300, any computing device or group of computing devices, such as any one or more of APs 142/200, servers 128, edge computing devices 150, network node 500, etc., may execute the functions described herein, and the disclosure is not limited in this respect.

For each selected pair of two APs including a first AP and a second AP, the computing device obtains CSI data including amplitude and phase information associated with a wireless signal transmitted between the first AP and the second AP (1702). For example, the computing device may obtain phase information from CSI samples collected over a selected period of time (e.g., one hour). In some examples, the samples may be averaged over shorter time periods (e.g., 10-100 milliseconds) to filter noise present in the CSI samples. The measured phases are then assigned to phase bins such as described above with reference to FIGS. 15A-15D.

The computing device determines an amount of multipath for the wireless signal based on the CSI information for the wireless signal (1704). For example, the computing device may determine an amount of multipath based on CSI amplitude and/or phase information for the wireless signal. In some examples, the computing device determines an amount of multipath based on a histogram of the CSI phase information for the selected period of time.

The computing device compares the amount of multipath of the wireless signal to a threshold (1706). In some examples, the threshold is a configurable value indicative of an acceptable amount of multipath in the wireless signals which are to be used for determining distances between APs in the wireless network.

If the amount of multipath satisfies the threshold (YES branch of 1710), the computing device selects those RTT/RSSI distance measurements associated with the wireless signal for purposes of determining the location of the first AP or the second AP (1714). For example, RTT/RSSI measurements based on signals transmitted between a first AP and a second AP having less than the threshold amount of multipath are selected for purposes of determining the location of the first AP or the second AP. For such signals, the impact of any multipath on the RTT/RSSI measurements is likely to be low enough so as not to result in an inaccurate distance determination between the two APs (or less than an acceptable amount of error in the distance determination). Hence, the determined location of one of the two APs based on those distance measurements is similarly likely to be accurate to within an acceptable amount of error.

In some examples, if the amount of multipath does not satisfy the threshold (NO branch of 1710), the computing device does not select those RTT/RSSI distance measurements associated with the wireless signal for purposes of determining the distance between the first AP and the second AP. For example, RTT/RSSI measurements based on wireless signals having more than the threshold amount of multipath are not selected for use in determining the distance between the first AP and the second AP. For these signals, the impact of any multipath on the RTT/RSSI measurements is likely to be too high such that their use would result in an inaccurate distance measurement between the two APs (or more than an acceptable amount of error in the distance measurement). Hence, the determined location of one of the two APs based on those erroneous distance measurements is similarly not likely to be accurate to within an acceptable amount of error.

In some examples, RTT/RSSI measurements based on signals transmitted between two APs having more than the threshold amount of multipath (NO branch of 1710) are corrected based one or more error correction factor(s) corresponding to the amount of multipath present in the signal (1712). The corrected RTT/RSSI distance measurements associated with the wireless signal may then be selected for purposes of determining the location of the first AP or the second AP (1714). In some examples, rather than correcting the distance measurement associated with such wireless signals (1714), the distance measurements associated with such wireless signals are not used when determining the locations of the first AP and the second AP.

The computing device determines whether there are more AP pairs having distance measurements based on wireless signals for which the CSI information is to be analyzed (1716). If there are more AP pairs (YES branch of 1716), the computing device selects the next AP pair (918) and repeats steps (1702)-(1714) for a wireless signal transmitted between a first AP and a second AP of the next AP pair. If there are no more AP pairs (NO branch of 1716), the computing device determines, for each of a plurality of APs, the location of the AP based on the selected distance measurements for the AP (1720). In this way, only those RTT/RSSI distance measurements based on wireless signals having less than the threshold amount of multipath are used to determine the locations of the APs in the wireless network.

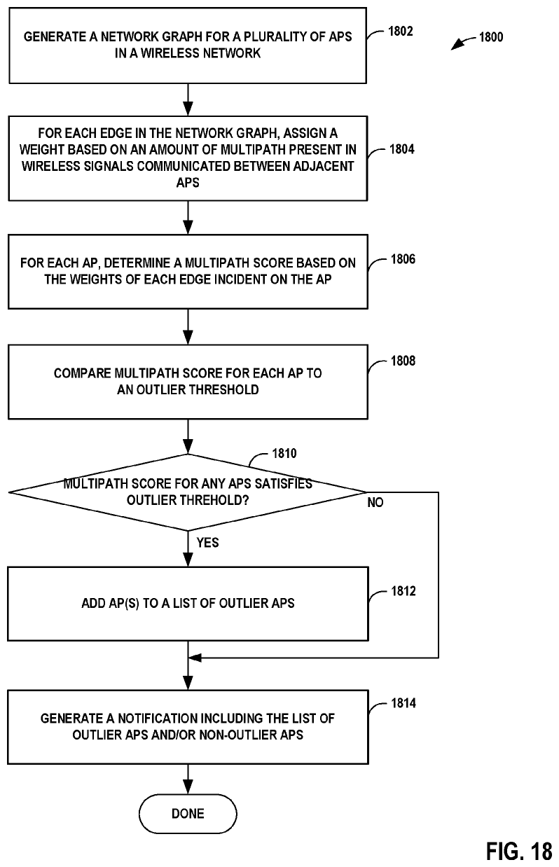

FIG. 18 is a flowchart of an example process (1800) by which a computing device identifies one or more outlier APs in a wireless network based on CSI information, in accordance with one or more techniques of the disclosure. The computing device may include one or more processor(s) of a network management system, such as processor(s) 306 of NMS 130/300 as shown in FIGS. 1A, 1B and/or FIG. 3, or other computing device executing deployed AP location module 135/372. In such examples, the wireless devices may include a plurality of APs, such as APs 142/200 as shown in FIGS. 1A and/or FIG. 2, or any other devices in a wireless network, such as wireless networks 106 as shown in FIGS. 1A and 1B. In addition, although process (1800) is described as being executed out by NMS 130/300, any computing device or group of computing devices, such as any one or more of APs 142/200, servers 128, edge computing devices 150, network node 500, etc., may execute the functions described herein, and the disclosure is not limited in this respect.

The computing device generates a network graph for a plurality of APs in a wireless network (1802). The nodes in the network graph represent AP and the edges in the network graph represent wireless connections between adjacent APs. For each edge in the network graph, the computing device assigns a weight based on an amount of multipath present in wireless signals communicated between adjacent APs (1804). The amount of multipath may be determined based on CSI information for the wireless signals. For example, for pair of adjacent APs including a first AP and a second AP, the computing device obtains CSI data (including, for example, amplitude and phase information) associated with a wireless signal transmitted between the first AP and the second AP. For example, the computing device may obtain phase information from CSI samples collected over a selected period of time (e.g., fifteen minutes, one hour, one day, etc.). In some examples, the samples may be averaged over shorter time periods (e.g., 10-100 milliseconds) to filter noise present the CSI samples. The measured phases are then assigned to phase bins such as described above with reference to FIGS. 15A-15D. The computing device determines an amount of multipath for the wireless signal based on the CSI information for the wireless signal. For example, the computing device may determine an amount of multipath based on CSI amplitude and/or phase information for the wireless signal. In some examples, the computing device determines an amount of multipath based on a phase histogram variance for the selected period of time.

For each AP, the computing device determines a multipath score based on the weights of each edge incident on the AP (1806). For example, a multipath score for a single AP may be determined based on the following equation:

$$Multipath Score = \frac{{\sum }_{i = 1}^{n} {EdgeWeight}_{i}}{n} \qquad ( 7 )$$

where
N=total number of incident edges for the AP, and
Edge Weightᵢ=weight (based on an amount of multipath) assigned to the ith incident edge for the AP.

The computing device compares the multipath score for each AP in the wireless network to an outlier threshold (1808). In some examples, the outlier threshold is a configurable value indicative of an amount of multipath in the wireless signals for purposes of identifying outlier APs in a wireless network.

For each AP having a multipath score that satisfies the outlier threshold (YES branch of 1810), the computing device adds the AP to a list of outlier APs (1812). For example, if the multipath score for a particular AP determined according to Equation 8 above exceeds the outlier threshold (that is, the multipath score for the AP, indicates a relatively high level of multipath which could be indicative of an outlier AP) the computing device adds the AP to a list of outlier APs.

For each AP having a multipath score that does not satisfy the outlier threshold (NO branch of 1810), the computing device does not add the AP to the list of outlier APs. For example, if the multipath score for a particular AP determined according to Equation 8 above does not exceed the outlier threshold (that is, the multipath score for the AP, indicates a relatively lower level of multipath which could be indicative that the AP is not an outlier AP) the computing device would not add the AP to the list of outlier APs.

In some examples, the computing device generates a notification including the list of outlier APs and/or non-outlier APs (1814). The notification may further include a recommendation to move the outlier AP(s) to a new/different location where they would experience a lesser amount of multipath. Process (1800) may be repeated on a periodic, scheduled or on-demand basis and the list of outlier APs updated over time to ensure the outlier AP information is kept current.

The techniques of the disclosure may provide one or more technical advantages and practical applications. The techniques enable a system to determine an amount of multipath present in wireless signals communicated between wireless devices associated with a wireless network. In some examples, the amount of multipath present in wireless signals is a consideration when selecting measurements to be used in an AP location determination process. In this way, only distance measurements (such as RTT and/or RSSI measurements) having less than a threshold amount of multipath are considered for purposes of determining the locations of the deployed APs, thus increasing the accuracy of the determined AP locations. In addition, in examples where a correction corresponding to the amount of multipath is applied to distance measurements associated with the wireless signal, a greater number of RTT/RSSI distance measurements may be available for use when determining locations of deployed APs. In general, the more distance measurements between two APs that are available, the more accurate are the determined distances between the two APs and also the determined locations of the two APs. Also, having more distance measurements available means there may be fewer APs for which there are insufficient distance measurements on which to determine the APs location. The ability to automatically and accurately determine the location of deployed APs may greatly reduce the cost to deploy a wireless network because it is not necessary to dispatch technicians to conduct a survey of the entire site. Determination of APs location using channel state information increases the accuracy of the determined AP locations as compared to the error-prone and time-consuming process of manually measuring the locations of hundreds or even thousands of AP locations. In addition, the techniques may be used to detect when an AP is moved or when a new AP is installed, e.g., as a replacement for a faulty AP, in a slightly different location. Yet another benefit is that the techniques facilitate automated and remote verification of AP deployment locations without necessitating dispatching technicians to conduct an on-site survey. The techniques further provide ability to identify AP(s) that are experiencing a relatively greater amount of multipath and generate a notification including a recommendation to move the AP(s) to a new/different location where they would experience a lesser amount of multipath. In other examples, the techniques provide for identification of outlier APs in a wireless network. In such examples, the system may automatically generate notifications including an identification of one or more outlier APs and/or a recommendation to move the outlier APs to a new or different location including relatively less multipath, or to adjust the environment around the AP so that wireless signals communicated to and/or from the AP experiences less multipath. This can further increase the operational performance of the wireless network as fewer signals associated with high multipath will be present in the wireless network. The techniques support the provision of highly accurate location-based services at a site, which depend upon the locations of each of AP being known to a high degree of accuracy. In addition, the CSI information and/or amount of multipath present in wireless signals transmitted between a plurality of APs in a wireless network determined as described herein may further be used for RF coverage optimization and radio resource management (RRM) of the APs at the site, such as channel and transmit power level selection.

The techniques described herein may be implemented using software, hardware and/or a combination of software and hardware. Various examples are directed to apparatus, e.g., mobile nodes, mobile wireless terminals, base stations, e.g., access points, communications system. Various examples are also directed to methods, e.g., method of controlling and/or operating a communications device, e.g., wireless terminals (UEs), base stations, control nodes, access points and/or communications systems. Various examples are also directed to non-transitory machine, e.g., computer, readable medium, e.g., ROM, RAM, CDs, hard discs, etc., which include machine readable instructions for controlling a machine to implement one or more steps of a method.

Numerous additional variations on the methods and apparatus of the various examples described above will be apparent to those skilled in the art in view of the above description. Such variations are to be considered within the scope of this disclosure. The methods and apparatus may be, and in various examples are, used with BLE, LTE, CDMA, orthogonal frequency division multiplexing (OFDM), and/or various other types of communications techniques which may be used to provide wireless communications links between access nodes and mobile nodes. In some examples the access nodes are implemented as base stations which establish communications links with user equipment devices, e.g., mobile nodes, using OFDM and/or CDMA. In various examples the mobile nodes are implemented as notebook computers, personal data assistants (PDAs), or other portable devices including receiver/transmitter circuits and logic and/or routines, for implementing the methods.

In the detailed description, numerous specific details are set forth in order to provide a thorough understanding of some examples. However, it will be understood by persons of ordinary skill in the art that some examples may be practiced without these specific details. In other instances, well-known methods, procedures, components, units and/or circuits have not been described in detail so as not to obscure the discussion.

Some examples may be used in conjunction with various devices and systems, for example, a User Equipment (UE), a Mobile Device (MD), a wireless station (STA), a wireless terminal (WT), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some examples may be used in conjunction with devices and/or networks operating in accordance with existing Wireless-Gigabit-Alliance (WGA) specifications (Wireless Gigabit Alliance, Inc. WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for

Information Technology-Telecommunications and Information Exchange Between Systems
Local and Metropolitan Area Networks—Specific Requirements-Part 11: Wireless LAN Medium Access Control (MAC) and Physical Layer (PHY) Specifications—Amendment 4: Enhancements for Very High Throughput for Operation in Bands below 6 GHZ”, December 2013); IEEE 802.11ad (“IEEE P802.11ad-2012, IEEE Standard for Information Technology—Telecommunications and Information Exchange Between Systems-Local and Metropolitan Area Networks—Specific Requirements-Part 11: Wireless LAN Medium Access Control (MAC) and Physical Layer (PHY) Specifications-Amendment 3: Enhancements for Very High Throughput in the 60 GHz Band”, 28 Dec. 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHZ)), IEEE 802.11-2016 and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.5, August 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, or operate using any one or more of the above protocols, and the like.

Some examples may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some examples may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other examples may be used in various other devices, systems and/or networks.

Some demonstrative examples may be used in conjunction with a WLAN (Wireless Local Area Network), e.g., a Wi-Fi network. Other examples may be used in conjunction with any other suitable wireless communication network, for example, a wireless area network, a “piconet”, a WPAN, a WVAN, and the like.

Some examples may be used in conjunction with a wireless communication network communicating over a frequency band of 2.4 Ghz, 5 GHz and/or 60 GHz. However, other examples may be implemented utilizing any other suitable wireless communication frequency band(s), for example, an Extremely High Frequency (EHF) band (the millimeter wave (mmWave) frequency band), e.g., a frequency band within the frequency band of between 20 GhH and 300 GHz, a WLAN frequency band, a WPAN frequency band, a frequency band according to the WGA specification, and the like.

While the above provides just some simple examples of the various device configurations, it is to be appreciated that numerous variations and permutations are possible. Moreover, the technology is not limited to any specific channels, but is generally applicable to any frequency range(s)/channel(s). Moreover, and as discussed, the technology may be useful in the unlicensed spectrum.

Although examples are not limited in this regard, discussions utilizing terms such as, for example, “processing,” “computing,” “calculating.” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although examples are not limited in this regard, the terms “plurality” and “a plurality” as used herein may include, for example, “multiple” or “two or more.” The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The examples have been described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the examples illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including any communications channel(s)/elements/lines connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the examples described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The examples are described in relation to enhanced communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The example systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

While the above-described flowcharts have been discussed in relation to a particular sequence of events, it should be appreciated that changes to this sequence can occur without materially effecting the operation of the example(s). Additionally, the example techniques illustrated herein are not limited to the specifically illustrated examples but can also be utilized with the other examples and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, DensiFi SIG, Unifi SIG, 3GPP LAA (licensed-assisted access), and the like.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000TM automotive infotainment processors, Texas Instruments® OMAP™ automotive-grade mobile processors, ARM® Cortex™-M processors, ARM® Cortex-A and ARM926EJ-STM processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the examples is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed techniques may be readily implemented in software and/or firmware that can be stored on a storage medium to improve the performance of a programmed general-purpose computer with the cooperation of a controller and memory, a special purpose computer, a microprocessor, or the like. In these instances, the systems and methods can be implemented as program embedded on personal computer such as an applet, JAVA.RTM. or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there have at least been provided systems and methods for enhancing and improving conversational user interface. Many alternatives, modifications and variations would be or are apparent to those of ordinary skill in the applicable arts.

Accordingly, this disclosure is intended to embrace all such alternatives, modifications, equivalents and variations that are within the spirit and scope of this disclosure.

1. A system comprising:
one or more processors; and
a memory comprising instructions that when executed by the one or more processors cause the one or more processors to:
obtain a first plurality of distance measurements for each of a plurality of wireless signals transmitted between a first wireless device and a second wireless device, wherein a distance between the first wireless device and the second wireless device is known;
determine coefficients of a polynomial function describing a relationship between estimate errors introduced to the obtained first plurality distance measurements by multipath signals and a statistical spread of the obtained first plurality of distance measurements;
obtain a second plurality of distance measurements for each of a plurality of wireless signals transmitted between a third wireless device and a fourth wireless device, wherein a distance between the third wireless device and the fourth wireless device is unknown; and
correct each of the second plurality of distance measurements based on the determined coefficients of the polynomial function.

2. The system of claim 1, wherein to determine the coefficients of the polynomial function the memory further comprises instructions that when executed by the one or more processors cause the one or more processors to:
determine the coefficients of the polynomial function using a polynomial fitting algorithm.

3. The system of claim 1, wherein the statistical spread is calculated using one of: a root mean squared (RMS) deviation, variance, standard deviation, range and entropy of the first plurality of distance measurements.

4. The system of claim 1, the memory further comprising instructions that when executed by the one or more processors cause the one or more processors to:
determine a distance between the third wireless device and the fourth wireless device based on the corrected second plurality of distance measurements.

5. The system of claim 1, wherein the memory comprising instructions that when executed by the one or more processors cause the one or more processors to determine coefficients of the polynomial function is further comprising instructions that when executed by the one or more processors cause the one or more processors to:
determine the statistical spread of the obtained first plurality of distance measurements; and
determine estimated distance measurement errors for each of the first plurality of distance measurements based on the determined statistical spread of the obtained first plurality of distance measurements.

6. The system of claim 1, wherein the memory comprising instructions that when executed by the one or more processors cause the one or more processors to correct each of the second plurality of distance measurements is further comprising instructions that when executed by the one or more processors cause the one or more processors to:
determine a statistical spread of the obtained second plurality of distance measurements;
determine estimated distance measurement errors for each of the second plurality of distance measurements based on the determined statistical spread of the obtained second plurality of distance measurements; and
correct each of the second plurality of distance measurements based on the determined distance measurement errors.

7. The system of claim 6, the memory further comprising instructions that when executed by the one or more processors cause the one or more processors to:
correct each of the second plurality of distance measurements by subtracting the determined distance measurement errors from corresponding distance measurements of the second plurality of distance measurements.

8. The system of claim 1, wherein the first plurality of distance measurements include one of round-trip time (RTT) measurements between the first wireless device and the second wireless device or received signal strength indicator (RSSI) measurements of the wireless signal transmitted between the first wireless device and the second wireless device and wherein the second plurality of distance measurements include one of RTT measurements between the third wireless device and the fourth wireless device or RSSI measurements of the wireless signal transmitted between the third wireless device and the fourth wireless device.

9-21. (canceled)

22. A method comprising:
obtaining a first plurality of distance measurements for each of a plurality of wireless signals transmitted between a first wireless device and a second wireless device, wherein a distance between the first wireless device and the second wireless device is known;
determining coefficients of a polynomial function describing a relationship between estimate errors introduced to the obtained first plurality of distance measurements by multipath signals and a statistical spread of the obtained first plurality of distance measurements;
obtaining a second plurality of distance measurements for each of a plurality of wireless signals transmitted between a third wireless device and a fourth wireless device, wherein a distance between the third wireless device and the fourth wireless device is unknown; and
correcting each of the second plurality of distance measurements based on the determined coefficients of the polynomial function.

23. The method of claim 22, wherein determining the coefficients of the polynomial function further comprises:
determining the coefficients of the polynomial function using a polynomial fitting algorithm.

24. The method of claim 22, wherein the statistical spread is calculated using one of: a root mean squared (RMS) deviation, variance, standard deviation, range and entropy of the first plurality of distance measurements.

25. The method of claim 22, further comprising:
determining a distance between the third wireless device and the fourth wireless device based on the corrected second plurality of distance measurements.

26. The method of claim 22, wherein correct each of the second plurality of distance measurements further comprises:
determining the statistical spread of the obtained first plurality of distance measurements; and
determining estimated distance measurement errors for each of the first plurality of distance measurements based on the determined statistical spread of the obtained first plurality of distance measurements.

27. The method of claim 22, wherein determining coefficients of the polynomial function further comprises:
determining a statistical spread of the obtained second plurality of distance measurements;
determining estimated distance measurement errors for each of the second plurality of distance measurements based on the determined statistical spread of the obtained second plurality of distance measurements; and
correcting each of the second plurality of distance measurements based on the determined distance measurement errors.

28. The method of claim 27, further comprising correcting each of the second plurality of distance measurements by subtracting the determined distance measurement errors from corresponding distance measurements of the second plurality of distance measurements.

29. The method of claim 22, wherein the first plurality of distance measurements include one of round-trip time (RTT) measurements between the first wireless device and the second wireless device or received signal strength indicator (RSSI) measurements of the wireless signal transmitted between the first wireless device and the second wireless device and wherein the second plurality of distance measurements include one of RTT measurements between the third wireless device and the fourth wireless device or RSSI measurements of the wireless signal transmitted between the third wireless device and the fourth wireless device.

30-42. (canceled)

43. Non-transitory computer-readable media comprising instructions that when executed by the one or more processors cause the one or more processors to:
obtain a first plurality of distance measurements for each of a plurality of wireless signals transmitted between a first wireless device and a second wireless device, wherein a distance between the first wireless device and the second wireless device is known;
determine coefficients of a polynomial function describing a relationship between estimate errors introduced to the obtained first plurality distance measurements by multipath signals and a statistical spread of the obtained first plurality of distance measurements;
obtain a second plurality of distance measurements for each of a plurality of wireless signals transmitted between a third wireless device and a fourth wireless device, wherein a distance between the third wireless device and the fourth wireless device is unknown; and
correct each of the second plurality of distance measurements based on the determined coefficients of the polynomial function.

44-53. (canceled)

54. The system of claim 1, wherein the memory comprising instructions that when executed by the one or more processors cause the one or more processors to obtain the first plurality of distance measurements for each of the plurality of wireless signals transmitted between the first wireless device and the second wireless device is further comprising instructions that when executed by the one or more processors cause the one or more processors to:
obtain channel state information (CSI) information for each of the plurality of wireless signals transmitted between the first wireless device and the second wireless device;
for each of the plurality of wireless signals, determine an amount of multipath of the wireless signal based on the CSI information;
for each of the plurality of wireless signals, compare the amount of multipath of the wireless signal to a threshold; and
select distance measurements between the first wireless device and the second wireless device corresponding to the wireless signals for which the amount of multipath satisfies the threshold.

55. The system of claim 1, wherein to determine the coefficients of the polynomial function the memory further comprises instructions that when executed by the one or more processors cause the one or more processors to:
determine the coefficients of the polynomial function using a curve fitting algorithm.

56. The method of claim 22, wherein determining the coefficients of the polynomial function further comprises:
determining the coefficients of the polynomial function using a curve fitting algorithm.
